(19) United States
(12) Patent Application Publication
(10) Pub. No.: US 2026/0268218 A1
(43) Pub. Date: Sep. 10, 2026

(54) METHODS AND SYSTEMS FOR HIGH-PERFORMING VIRTUAL METROLOGY

(71) Applicant: Gauss Labs Inc., Palo Alto, CA (US)

(72) Inventors: Sol Kwon, Seoul (KR); Guntitat Sawadwuthikul, Bangkok (TH); Jiae Kim, Seoul (KR); Pil Sung Jo, Seoul (KR); Yuanyuan Wang, Palo Alto, CA (US); Simon Zabrocki, Seoul (KR)

(21) Appl. No.: 19/534,562

(22) Filed: Feb. 9, 2026

Related U.S. Application Data
(60) Provisional application No. 63/762,606, filed on Feb. 24, 2025.
(60) Provisional application No. 63/946,336, filed on Dec. 22, 2025.

(51) Int. Cl. G06N 20/00; G06F 18/23

(52) U.S. Cl. CPC G06N 20/00; G06F 18/23

(57) ABSTRACT

Described herein are systems and methods for high-performing virtual metrology. Methods can include receiving a sample dataset and a feature dataset, processing the sample dataset and feature dataset to increase the dimensionality yielding enhanced datasets, determining one or more groups of objects within the enhanced datasets by clustering each group based on at least an object-level similarity to yield clustered datasets, optimizing the clustered datasets to yield a training dataset, and training a Virtual Metrology (VM) model using the training dataset, wherein the VM model may be used to predict a metrology measurement.

### CROSS-REFERENCE TO RELATED APPLICATIONS

This application claims the benefit of U.S. Provisional Application No. 63/946,336, filed Dec. 22, 2025, and U.S. Provisional Application No. 63/762,606, filed Feb. 24, 2025, each of which is incorporated by reference herein in its entirety.

### BACKGROUND

Metrology and Inspection (MI) play an important and useful role in semiconductor manufacturing. Recently, some MI methods have faced significant technical challenges due to at least the increasing complexity of semiconductor devices, high throughput demands, and the need for extremely low measurement uncertainty. These factors can lead to an increase in noise and reduced clarity in microscopic images of objects patterned on wafers. These technical challenges can make the practical implementation of virtual metrology (VM) difficult and impractical. Some studies have proposed advanced data preprocessing methodologies to enhance model updatability and adaptability. However, these methods often lack scalability as they may depend on users with specialized domain expertise.

Recognized herein is the need for systems and methods for high-performing virtual metrology in semiconductor manufacturing.

### SUMMARY

Provided herein are systems and methods for high-performing virtual metrology in semiconductor manufacturing. Systems and methods herein can provide technical solutions for at least addressing increased noise and reduced clarity in microscopic images. Additionally, systems and methods herein can provide technical solutions for at least reducing process variability in semiconductor manufacturing. Further, systems and methods herein can provide at least scalable solutions without specialized domain expertise.

Data quality and quantity can be important and useful characteristics of a dataset for building a powerful machine learning model. In semiconductor manufacturing, at least these characteristics can be technically difficult or impractical to obtain, thereby making the technical implementation of virtual metrology difficult in practice. Recent studies have proposed advanced data preprocessing methodologies to enhance model updatability and adaptability. However, these methods often lack scalability as they may depend on specialized domain expertise including but not limited to key process variables identification, process integration and control, equipment and material properties, and chemical reactions. To address these technical problems, systems and methods herein can employ advanced data aggregation methodologies to identify and use essential data from process variables collected across relevant process recipes and operations at scale. Systems and methods can further include a simple yet powerful data-driven group-wise feature transformation module (GroFT). GroFT can dynamically group features that share similar data characteristics using, e.g., a distance-based clustering technique, and can then apply specifically optimized data transformation for each feature group. Compared to other approaches, this framework can achieve superior performance as demonstrated herein with publicly available datasets and a high-volume dataset from a major semiconductor manufacturer.

In an aspect, disclosed herein is a method for training a virtual metrology (VM) model. In some embodiments, the method comprises (a) receiving (i) a sample dataset comprising a plurality of datasets and data types obtained from a plurality of sources and (ii) a feature dataset comprising a plurality of features obtained from at least one process of at least one source of the plurality of sources. In some embodiments, the method comprises (b) processing the sample dataset and the feature dataset to increase a dimensionality of the sample dataset and the feature dataset, thereby yielding an enhanced dataset. In some embodiments, the method comprises (c) determining one or more groups of objects within the enhanced dataset by clustering each group based at least on an object-level similarity to yield clustered datasets. In some embodiments, each object represents at least (i) one dataset and data type from the enhanced dataset and (ii) one feature from the enhanced dataset. In some embodiments, the method comprises (d) optimizing at least one clustered dataset using a set of transformations to yield a training dataset for training the VM model. In some embodiments, the method comprises (e) using the training dataset to train the VM model to predict a metrology measurement. In some embodiments, the sample dataset comprises at least one of (i) real metrology measurements of at least one wafer processed by a semiconductor process or (ii) parameters of the semiconductor process. In some embodiments, the feature dataset comprises at least one of (i) sensor measurements from at least one process equipment used to process a wafer by a semiconductor process or (ii) parameters of the semiconductor process. In some embodiments, the method further comprises generating the sample dataset obtained from the plurality of sources. In some embodiments, the plurality of sources comprises at least one processing equipment having at least one chamber in a semiconductor process. In some embodiments, the method further comprises generating the feature dataset obtained from the at least one process of the at least one source. In some embodiments, the at least one process comprises at least one recipe used to process a wafer by a semiconductor process. In some embodiments, the at least one process of the at least one source comprises a process from an upstream process or from a downstream process, relative to the at least one source. In some embodiments, the processing in (b) comprises concatenating the sample dataset and the feature dataset to increase the dimensionality of the enhanced dataset. In some embodiments, the dimensionality resulting from (b) comprises at least two dimensions of parameters, samples, tasks, or processes. In some embodiments, the training dataset has a lower dimensionality than the at least one clustered dataset. In some embodiments, the clustering in (c) comprises using (i) a data-driven, group-wise feature transformation or (ii) domain knowledge. In some embodiments, the clustering in (c) comprises using a distance clustering model to determine a correlation coefficient indicative of the object-level similarity between different objects within the enhanced dataset. In some embodiments, the optimizing in (d) further comprises applying a set of transformations unique to each clustered dataset In some embodiments, each set of transformations comprises at least one of feature normalization, time-aware normalization, dimensionality reduction, feature engineering, feature encoding, feature compression, hyperparameter optimization, or deep learning. In some embodiments, the method further comprises combining each clustered dataset to yield the training dataset. In some embodiments, the method further comprises updating the trained VM model by clustering the one or more groups of objects in the enhanced dataset using a similarity different than the object-level similarity. In some embodiments, the method further comprises updating the trained VM model by optimizing each clustered dataset using transformations different than the set of transformations. In some embodiments, the method further comprises updating the trained VM model when a new object is available. In some embodiments, the method further comprises using the predicted metrology measurement in a semiconductor process for reducing process variability in a wafer processed by the semiconductor process. In some embodiments, the method further comprises using the predicted metrology measurement in a semiconductor process for characterizing at least a real metrology measurement of a wafer processed by the semiconductor process. In some embodiments, the method further comprises using the predicted metrology measurement in a semiconductor process for characterizing each object processed on a wafer using the semiconductor process. In some embodiments, using the training dataset to train the VM model reduces computing time or computing resources by at least 1%-5% compared to training a VM model using a different training dataset than the training dataset. In some embodiments, the different training dataset comprises a dataset without object-level similarity. In some embodiments, the method further comprises validating the trained VM model by determining a difference between the predicted metrology measurement and a real metrology measurement determined by domain expertise. In some embodiments, the trained VM model comprises a machine learning model. In some embodiments, the plurality of datasets and data types comprises at least one of (i) structured or unstructured data, (ii) data form, or (iii) type of data, each associated with process equipment or a process performed by the process equipment. In some embodiments, the plurality of datasets and data types is determined from fault detection and classification (FDC) data. In some embodiments, the plurality of datasets and data types is associated with metrology or characteristics of a wafer processed by process equipment using a process. In some embodiments, the method further comprises determining a credibility score for the predicted metrology measurement of the trained VM model. In some embodiments, the method further comprises updating the trained VM model when the credibility score does not meet a threshold value. In some embodiments, the credibility score is determined using normalized root mean square error (RMSE) or normalized mean absolute error MAE. In some embodiments, the threshold value is at least about 0.10. In some embodiments, the method further comprises monitoring a prediction error between the predicted metrology measurement of the trained VM model and a real metrology measurement determined by real or physical metrology. In some embodiments, the method further comprises updating the trained VM model based at least on the prediction error when the prediction error exceeds a threshold value.

In another aspect, disclosed herein is a computer program product for training a virtual metrology (VM) model, the computer program product comprising at least one non-transitory computer-readable medium having computer-readable program code portions embodied therein, the computer-readable program code portions comprising: an executable portion configured to receive (i) a sample dataset comprising a plurality of datasets and data types obtained from a plurality of sources and (ii) a feature dataset comprising a plurality of features obtained from at least one process of at least one source of the plurality of sources; an executable portion configured to process the sample dataset and the feature dataset to increase the dimensionality of the sample dataset and the feature dataset, thereby yielding an enhanced dataset; an executable portion configured to determine one or more groups of objects within the enhanced dataset by clustering each group based at least on an object-level similarity to yield clustered datasets, wherein each object represents at least (i) one dataset and data type from the enhanced dataset and (ii) one feature from the enhanced dataset; an executable portion configured to optimize at least one clustered dataset using a set of transformations to yield a training dataset for training the VM model; and an executable portion configured to use the training dataset to train the VM model to predict a metrology measurement.

In another aspect, disclosed herein is a system comprising at least one processor and instructions executable by the at least one processor to cause the at least one processor to perform operations comprising: (a) receiving (i) a sample dataset comprising a plurality of datasets and data types obtained from a plurality of sources and (ii) a feature dataset comprising a plurality of features obtained from at least one process of at least one source of the plurality of sources; (b) processing the sample dataset and the feature dataset to increase the dimensionality of the sample dataset and the feature dataset, thereby yielding an enhanced dataset; (c) determining one or more groups of objects within the enhanced dataset by clustering each group based at least on an object-level similarity to yield clustered datasets, wherein each object represents at least (i) one dataset and data type from the enhanced dataset and (ii) one feature from the enhanced dataset; (d) optimizing at least one clustered dataset using a set of transformations to yield a training dataset for training the VM model; and (e) using the training dataset to train the VM model to predict a metrology measurement.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the present disclosure. Accordingly, the drawings and description are to be regarded as illustrative in nature and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the present disclosure contained in the specification, the specification is intended to supersede and/or take precedence over any such contradictory material.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings of which:

FIG. 1 depicts a non-limiting example of a method for training a virtual metrology (VM) model, in accordance with some embodiments.

FIG. 2 depicts a non-limiting example of a method for generating datasets, in accordance with some embodiments.

FIGS. 3A-3C depict a non-limiting example framework for advanced data aggregation methodologies as described and claimed herein, in some embodiments. FIG. 3A depicts a non-limiting example of inputting datasets to a sample coalescing and feature concatenation model.

FIG. 3B depicts a non-limiting example of a sample coalescing and feature concatenation model. FIG. 3C depicts a non-limiting example of data-driven group-wise feature transformation (GroFT).

FIG. 4 depicts a non-limiting generalization of a VM framework with group-wise modeling, in some embodiments.

FIG. 5 depicts a non-limiting generalization of horizontal grouping, in some embodiments.

FIG. 6 depicts a non-limiting example of horizontal grouping at chamber level, in some embodiments.

FIG. 7 depicts a non-limiting example of vertical grouping, in some embodiments,

FIG. 8 depicts a non-limiting example of task grouping, in some embodiments.

FIG. 9 depicts a non-limiting example of task grouping among data intelligent tasks.

FIG. 10 depicts a non-limiting illustrative comparison of two feature grouping methods, in some embodiments. Depicted are domain-knowledge based feature grouping and Group-wise Feature Transformation (GroFT) feature grouping. In some embodiments, GroFT uses correlation coefficients and distance-based agglomerative clustering methodologies. In FIG. 10 each object represents one feature, and different shapes represent different sources. In some embodiments, nearby features are grouped based on the distances between their correlation vectors.

FIG. 11 depicts a non-limiting example of a method for optimizing at least one dataset, in accordance with some embodiments.

FIG. 12 depicts a non-limiting example of a method for updating the trained VM model, in accordance with some embodiments.

FIG. 13 depicts a non-limiting example of a method for using a predicted metrology measurement, in accordance with some embodiments.

FIG. 14 depicts a non-limiting example of a method for validating the trained VM model, in accordance with some embodiments.

FIGS. 15A-15B depict a non-limiting visualization of feature groups from an example PHM-2016 dataset, in some embodiments. Features with similar data distributions are located closely. In some embodiments, features from the same group will undergo the same data transformation. FIG. 15A depicts a non-limiting example of Domain Knowledge Grouping, in some embodiments. FIG. 15B depicts a non-limiting example of Data-Driven Grouping, in some embodiments.

FIG. 16 depicts a non-limiting example of a computing device configured to perform methods herein, in some embodiments.

FIG. 17 depicts a non-limiting example of a web/mobile application provision system configured to perform methods herein, in some embodiments.

FIG. 18 depicts a non-limiting example of a cloud-based web/mobile application provision system configured to perform methods herein, in some embodiments.

### DETAILED DESCRIPTION

While various embodiments of the present disclosure have been shown and described herein, such embodiments are provided by way of example only. Numerous variations, changes, or substitutions may occur without departing from the present disclosure. It should be understood that various alternatives to the embodiments of the present disclosure described herein may be employed.

### Overview

The semiconductor industry has experienced significant growth, especially in recent years. This has been driven, at least in part, by demands for advance computing, integration of semiconductor-equipped devices into an increasing number personal and professional uses, and advanced chips for new technologies such as Artificial Intelligence (AI). This industry growth has not only increased the demand for more semiconductor devices but also more complex semiconductor devices with increased capability.

One example of this demand for increased complexity is increased computing density, where more computing power is desired from increasingly smaller footprints and feature size. In many cases, this results in miniaturization of features on semiconductor devices, in the desire to pack more transistors onto smaller chips. In other cases, this can also result in more complex packaging methodologies, where a number of chips are stacked together for increased density. Both approaches result in more complex semiconductor device components, often with an increasing number of intricate and sensitive microscopic features.

An important component of the semiconductor manufacturing industry is Metrology and Inspection (MI). MI methodologies can be important for ensuring the quality of these semiconductor devices, helping technicians validate the components are in consistent working order prior to downstream use. The trend of increasing complexity and miniaturization of features in semiconductor devices can pose challenges in the MI process, which often relies on visual inspection, e.g., physical or real metrology, of semiconductor features for verification.

Additionally, demand for an increasing quantity of semiconductor devices may pose further challenges, as MI methodologies are adapted for higher throughput.

Systems and methods for high-performance virtual metrology, described herein, can address MI technical challenges in the semiconductor industry by at least leveraging collected datasets during the semiconductor process, using advanced data processing methodologies and a trained Virtual Metrology model to predict metrology measurements with high accuracy. These systems and methods can address both the increased complexity and decreasing size of semiconductor features, as well as the demand for higher throughput in MI. Further, systems and methods herein can provide technical solutions for at least reducing process variability in semiconductor manufacturing, which can be demonstrated by improvements in process capability indices such as Cp or CpK.

Virtual metrology (VM) is a technique in semiconductor manufacturing that can replace, supplement, or augment physical metrology (or real metrology) by estimating the process outcomes without direct physical measurement. In many cases, direct physical measurement comes with high costs and demand in additional power and labor. Commonly built with statistical, computational, or machine learning models, the data-driven methodologies of VM utilize sensor, process parameters, and actual metrology data from manufacturing equipment. Integrating these models into manufacturing fabs can give the manufacturer complete measurements, allowing them to act proactively and reduce costs.

Since VM models may often be integrated with advanced process control (APC) and statistical process control (SPC) systems, developers often recommend extensive data to obtain high predictive accuracy. However, obtaining extensive data can be costly or impractical thereby resulting in scarce datasets for training VM models. Recently, various studies in semiconductor manufacturing have employed machine learning methodologies, such as those described in, for instance: P.-A. Dreyfus, F. Psarommatis, G. May and D. Kiritsis, “Virtual metrology as an approach for product quality estimation in Industry 4.0: a systematic review and integrative conceptual framework,” International Journal of Production Research, pp. 742-765, 2021, and S. Zabrocki, P. S. Jo, C. Park, D. Yim, S. Yun. and B.-J. Lee, “Adaptive Online Time-Series Prediction for Virtual Metrology in Semiconductor Manufacturing,” in 2023 34th Annual SEMI Advanced Semiconductor Manufacturing Conference (ASMC), New York, USA, 2023. (herein “ASMC34”), which are incorporated by reference herein for all purposes. Such methodologies have been proposed as solutions to VM, as they have exhibited prominent applications in the past decade.

Despite the potential of machine learning applications, developing a VM solution can come with many technical challenges. In many cases, a significant challenge in building a robust VM model is constructing a dataset of high quality and quantity which contains key process variables and abundant samples, such described in, for instance: N. G. Orji, Y. S. Obeng, C. Beitia, S. Mashiro and J. Moyne, Virtual Metrology White Paper-International Roadmap for Devices and Systems (IRDS), IEEE-International Roadmap for Devices and Systems (IRDS), 2018, which is incorporated by reference herein for all purposes. Developing such a dataset can often be technically challenging in semiconductor manufacturing due to noisy data from equipment sensors and expensive measurement data from physical metrology. In some cases, approaches to improve the data quality involve outlier removal and dimensionality reduction methodologies to eliminate artifacts and non-informative features, described in, for instance: P. Kang, H.-j. Lee, S. Cho, D. Kim, J. Park, C.-K. Park and S. Doh, “A virtual metrology system for semiconductor manufacturing,” Expert Systems with Applications, vol. 36, no. 10, pp. 12554-12561, 2009, and T. Wang, Y. Xie, Y.-S. Jeong and M. K. Jeong, “Dynamic sparse PCA: a dimensional reduction method for sensor data in virtual metrology,” Expert Systems with Applications, vol. 251, p. 123995, 2024, which are incorporated by reference herein for all purposes. Increasing the data quantity, on the other hand, may be less feasible or practical due to the metrology cost. Some studies have proposed models with updatability and adaptability to compensate for the use of an extensive training set, such as those described in, for instance ASMC34 herein and A. Urhan and B. Alakent, “Integrating adaptive moving window and just-in-time learning paradigms for soft-sensor design,” Neurocomputing, vol. 392, pp. 23-37, 2020, which is incorporated by reference herein for all purposes. Similarly, another study suggested adaptive modeling using larger datasets collected from multiple equipment while capturing the specificities among them, described in, for instance: M. Shin, M. Jung, S. Zabrocki, D.-H. Ro, H.-K. Jeong and D. Yim, “Model Aggregation for Virtual Metrology in High-Volume Manufacturing,” in Metrology, Inspection, and Process Control XXXVIII, San Jose, USA, 2024, which is incorporated by reference herein for all purposes. In many cases, these methodologies all use inductive bias on the data characteristics and do not provide specific treatment for each feature.

In some cases, however, another challenge of adopting a VM is the scalability issue. Since each process in the fabrication (e.g., etching, deposition, photolithography, etc.) does not necessarily share the process operations, equipment vendors, sensors, or wafer properties, building a VM solution or training a machine learning model and applying it to all processes can be impractical, as each use case may not share the data characteristic, requiring different treatment and modeling methodologies. In such cases, feature engineering can be useful in creating high-quality datasets, leading to better predictive modeling performance. To achieve this, field engineers can use their expertise to collaborate with VM developers, who apply their knowledge to choose and process the features manually using statistical or other methodologies. This process may help build high-performing models tailored to specific processes. However, while this approach improves predictive accuracy for a given process, it can be difficult to scale effectively across different processes in the fabrication.

### Methods for High-Performing Virtual Metrology

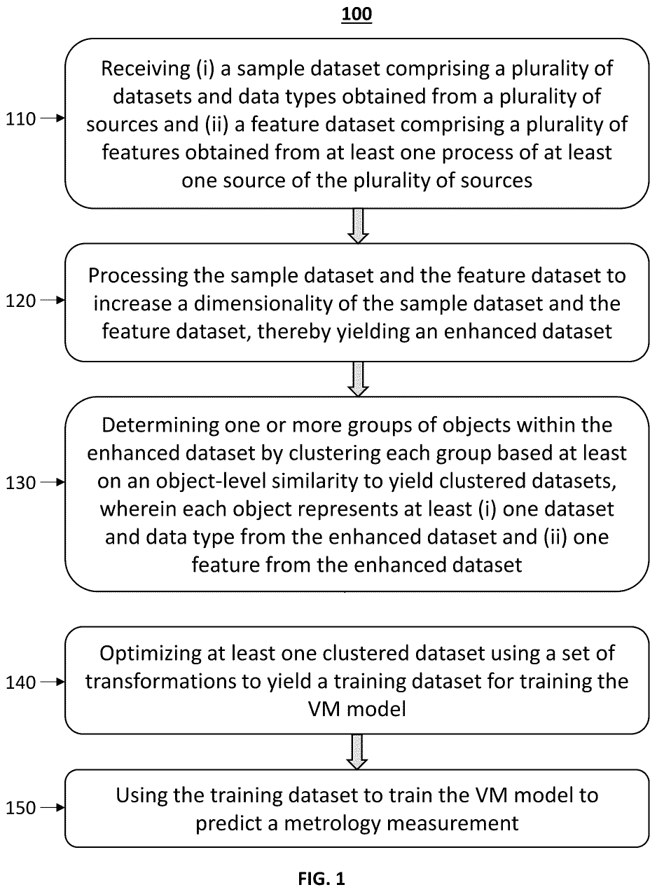

To mitigate at least these technical problems, provided herein are systems and methods for training a virtual metrology (VM) model to provide a scalable solution which may solve both data scarcity and quality problems. A non-limiting example of a method 100 for training a VM model is provided in FIG. 1. It will be understood that while operations of the methods provided herein are depicted sequentially, this arrangement is provided for logical flow, and any combination of operations of the method may be completed contemporaneously or in a different order.

Systems and methods herein can utilize data aggregation methodologies, e.g., sample coalescing and feature concatenation, which can be important and useful for developing high-performing VM machine learning models. To this end, herein is provided a data-driven group-wise feature transformation approach which can outperform baseline approaches. The technique utilizes correlation coefficients and a distance-based clustering algorithm to divide features into groups and apply different feature transformations. Additionally, the robustness of the framework's performance is herein validated through different tasks and evaluations of public datasets.

In some cases, the systems and methods of the present disclosure utilize two advanced data aggregation methodologies: (1) sample coalescing based on the fabrication processes that shares similar fabrication operations and (2) feature concatenation collected from other relevant processes that the same set of samples underwent and were operated before or after the process of interest. To secure high-quality data, a data-driven group-wise feature transformation method is proposed to optimize transformations specifically for each feature group, which uses no domain knowledge from field engineers and functions under a constrained budget. By integrating these aggregation methods with fine-tuned feature transformation methodologies, a notable improvement in the predictive performance of VM models is demonstrated when evaluated on real semiconductor manufacturing datasets.

### Sample Concatenation

In some embodiments, the method 100 comprises receiving at 110 a sample dataset comprising a plurality of datasets and data topes obtained from a plurality of sources, and a feature dataset comprising a plurality of features obtained from at least one process of at least one source of the plurality of sources. This sample dataset may then be processed at 120 to increase the dimensionality of the sample dataset and the feature dataset, thereby yielding an enhanced dataset.

Collecting and aggregating data from several sources can be useful in machine learning practice to increase the size of the training data. In semiconductor manufacturing, this can include combining data from groups of equipment, similar recipes, similar processes operating in different fabs, or multiple products with similar characteristics-all of which can be easily extracted and compared by the nomenclatures, which can be done programmatically. Although sample coalescing may significantly increase the sample size, it may also introduce disparities between data distributions from different sources, requiring proper treatment, as discussed in ASMC34, herein. In some embodiments, processing at 120 comprises concatenating the sample dataset and the feature dataset to increase the dimensionality of the dataset. In some embodiments, the increased dimensionality resulting from the processing at 120 comprises at least two dimensions of parameters, samples, tasks, or processes.

The sample dataset can comprise data from many different sources in the semiconductor manufacturing and metrology process, including raw manufacturing data consisting of tool sensor data, process parameters, historical measurement data, and outputs transformed data of highly informative features, including but not limited to pressure, temperature, gas flow rates, process time, voltage and current from power supplies, and tool status. In some embodiments, the sample dataset comprises at least one of metrology measurements of at least one wafer processed by a semiconductor process, or parameters of the semiconductor process. In the same way, the feature dataset may also comprise data from many different sources in the semiconductor manufacturing and metrology process. In some embodiments, the feature dataset comprises at least one of sensor measurements form at least one process equipment used to process a wafer by a semiconductor process, or parameters of the semiconductor process. In some cases, processing a wafer can include patterning objects or features on the wafer. In some cases, processing a wafer can include any semiconductor process used in semiconductor manufacturing.

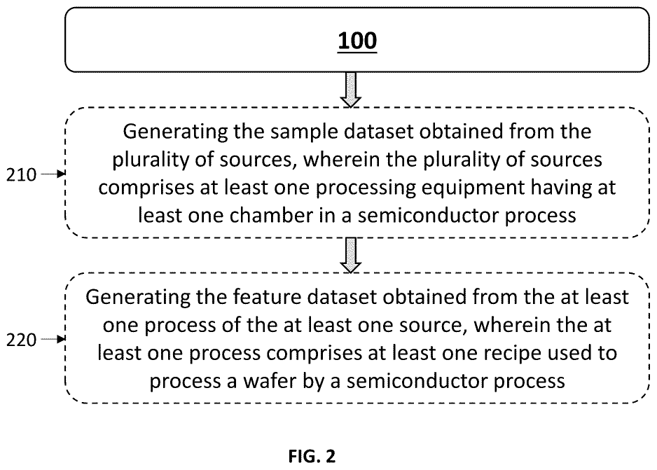

A non-limiting example of a method 200 for generating datasets is provided in FIG. 2. In the non-limiting example, the method 100 further comprises generating at 210 the sample dataset obtained from the plurality of sources, wherein the plurality of sources comprises at least one processing equipment having at least one chamber in a semiconductor process. The non-limiting example further comprises generating at 220 the feature dataset obtained from the at least one process of the at least one source, wherein the at least one process comprises at least one recipe used to process a wafer by a semiconductor process.

### Sample Coalescing

The process for manufacturing semiconductors is complex, involving multiple operations in a process sequence. Some processes include diffusion, where different layers may be created or modified by providing a specific chemical environment to a wafer. Processes may also include lithography, where patterned light and chemical masks are used to selectively protect specific areas of specific layers. Processes may further include etching, where unprotected areas are chemically removed. The success of each operation in a process sequence is directly the result of operations beforehand, and similarly, contributes to successful completion of later operations of the manufacturing process. To better quantify the relationship between operations, sample coalescing may be used.

In some embodiments, the at least one process of the at least one source comprises a process from an upstream process or from a downstream process, relative to the at least one source. In some cases, collecting additional features is more straightforward than sample coalescing in semiconductor manufacturing, as a sample undergoes many complex manufacturing processes. For instance, features can be aggregated across recipe operations or different equipment types within a unit process. On the unit process level, features collected from upstream and downstream unit processes that are conducted before and after the unit process may be concatenated based on the sample's manufacturing journey. Feature concatenation at scale significantly increases the data dimensionality but does not consider the data discrepancy from multiple sources.

### Data Grouping

In operation 120 of method 100 sample coalescing and feature concatenation increase the dataset size in both dimensions, number of samples, and number of features, respectively, without any preprocessing. Additional data grouping operations may offer specific data treatment for each feature by dividing the features into groups with similar characteristics and applying a unique transformation to each sample-feature group. In some cases, datasets grouped using this additional context can greatly improve the performance of the trained VM model, herein.

In some embodiments, the method 100 further comprises determining at 130 one or more groups of objects within the enhanced dataset by clustering each group based at least on an object level similarity to yield clustered datasets, wherein each object represents at least one dataset and data type from the enhanced dataset, and one feature from the enhanced dataset. In some embodiments, the training dataset has a lower dimensionality than the at least one clustered dataset.

In some embodiments, clustering at 130 comprises using (i) a data-driven, group-wise feature transformation (GroFT) or (ii) domain knowledge. In some cases, GroFT transforms data features based on characteristics of specific groups within the dataset. GroFT may be particularly well suited to handle the complexities of high-volume data, such as metrology datasets, by applying transformations tailored to different feature categories.

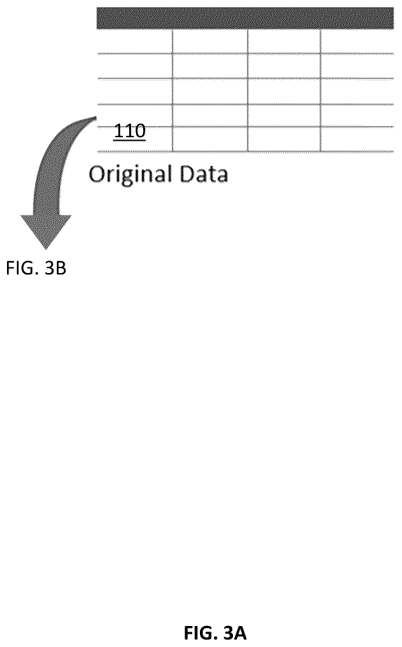

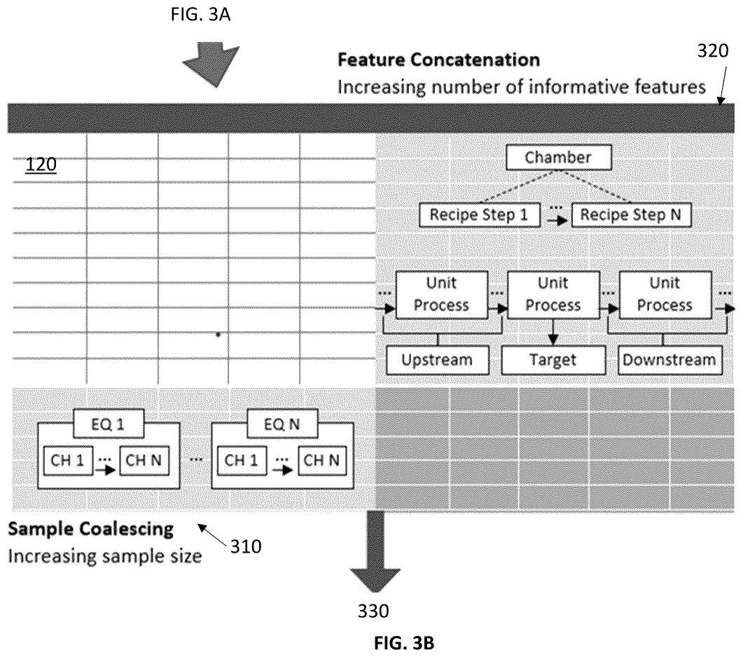

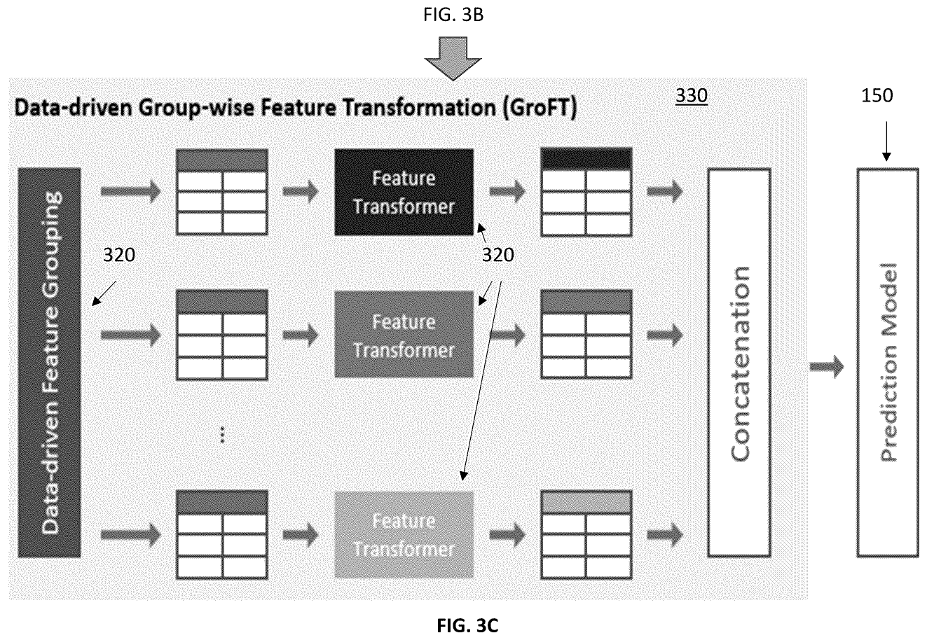

A non-limiting example of a framework for advanced data aggregation comprising data-driven, group-wise feature transformation is provided in FIGS. 3A-3B. In this non-limiting example, the sample dataset received at 110 of method 100 and depicted in FIG. 3A is processed at 120 using sample coalescing 310 and feature concatenation 320 depicted in FIG. 3B, described herein. This enhanced dataset may then be further modified using a data-driven, group-wise feature transformation (GroFT) at 330 depicted in FIG. 3C, which may comprise the operations of feature grouping at 130, and optimization at 140, yielding a training dataset which may be used by the trained VM model at 150.

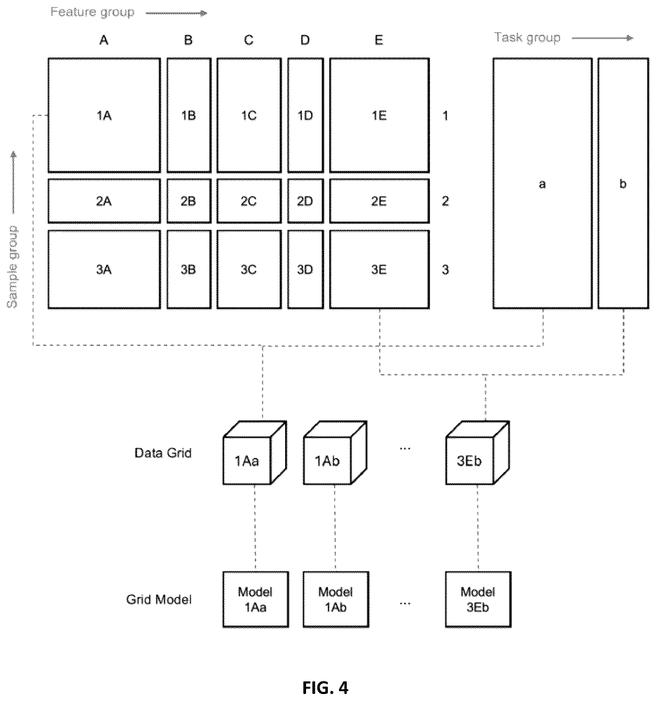

Provided herein is a non-limiting generalization of a VM framework with group-wise modeling, depicted in FIG. 4. The framework groups the data in three different dimensions: the parameters (vertical grouping), the samples (horizontal grouping), and the tasks (task grouping). The example in FIG. 4 shows that vertical grouping may divide the features into group A to E, horizontal grouping may divide the samples into group 1 to 3, and task grouping may divide the tasks into group a and b.

This non-limiting generalization of a VM framework builds one grid model per each data grid which is a triplet of a vertical group, a horizontal group, and a task group. In some cases, such a structure may provide better accuracy.

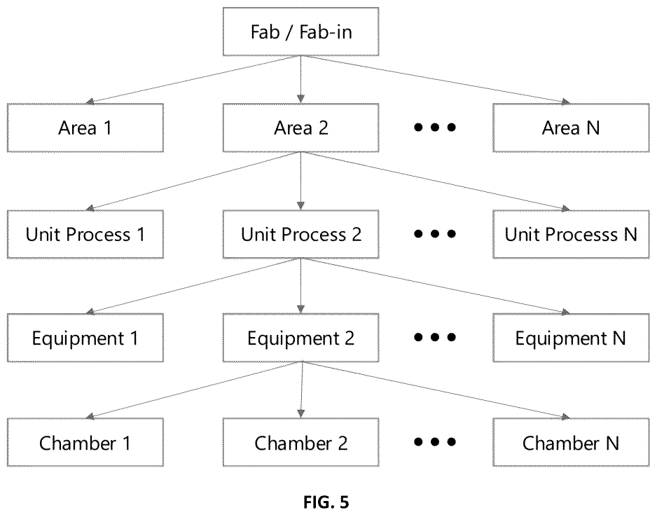

A non-limiting example of horizontal grouping is shown in FIG. 5. It will be noted, this is only an example setting of how systems may be configured. This hierarchy may change in many cases, such as for instance from factory to factory.

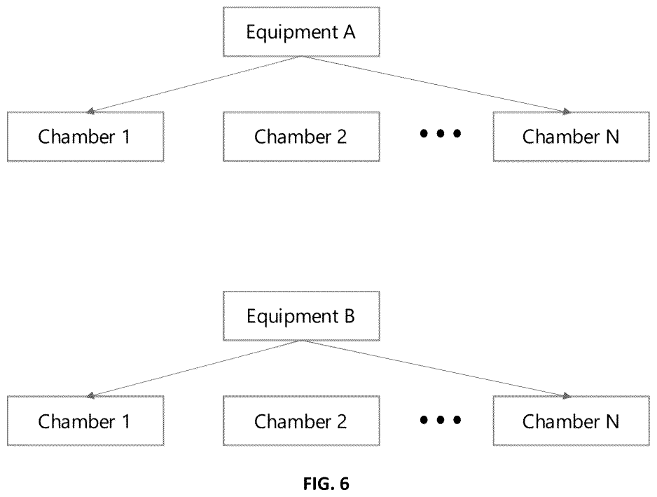

An example of horizontal grouping at chamber level is shown in FIG. 6. In some cases, horizontal grouping at chamber level may comprise a One-Chamber-One-Group configuration. In a One-Chamber-One-Group configuration, each chamber's data has its own horizontal group. In some cases, horizontal grouping at chamber level may comprise an All-Chamber-One-Group configuration. In an All-Chamber-One-Group configuration, all chambers are together under one horizontal group. In some cases, horizontal grouping at chamber level may comprise a Domain Knowledge Grouping configuration. In a Domain Knowledge Grouping configuration, the modeling group is based on the equipment information. Two examples of this are Model A of FIG. 6 comprising all chambers in Equipment A, and Model B of FIG. 6 comprising all chambers in Equipment B. In some cases, horizontal grouping at chamber level may comprise a Data-Driven Grouping configuration. In a Data-Driven Grouping configuration, chambers with similar characteristics across equipment share the same group.

The same technique used in horizontal grouping at chamber level described herein may be applied to other levels in the hierarchy structure of the VM. For example, a One-Area-One-Group configuration may be employed in domain-knowledge based grouping using the equipment names. In another example, a Data-Driven Grouping configuration may be employed for the entire fabrication.

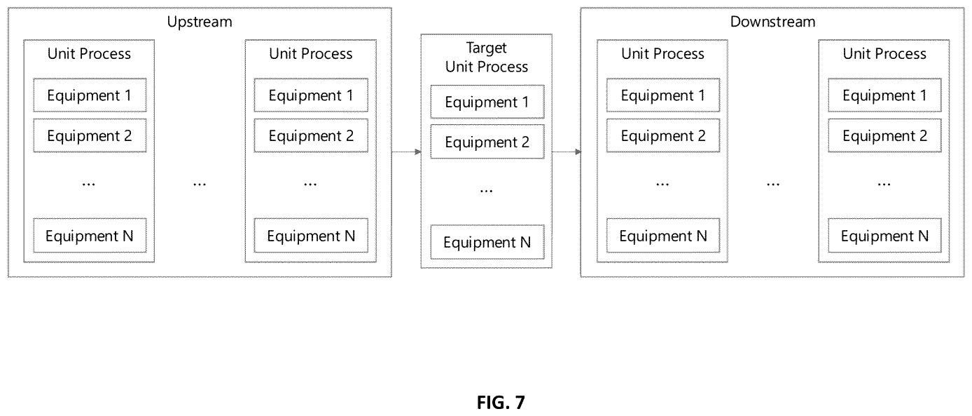

A non-limiting example of vertical grouping is shown in FIG. 7. It will be noted, this is only an example setting of how systems may be configured. This hierarchy may change in any cases, such as for instance from factory to factory.

In some cases, vertical grouping using process flow may comprise a One-Equipment-One-Group configuration. In a One-Equipment-One-Group configuration, features from each equipment belong to one vertical group. In some cases, vertical grouping using process flow may comprise a One-Unit-Process-One-Group configuration. In a One-Unit-Process-One-Group configuration, features across equipment within the same unit process belong to one vertical group. In some cases, vertical grouping using process flow may comprise a Chronological Grouping configuration. In a Chronological Grouping configuration, features are divided into groups based on the time collected. In one example of a Chronological Grouping configuration, all features from an upstream unit process or processes may be grouped together against the remaining features. In some cases, vertical grouping using process flow may comprise a Domain Knowledge Grouping configuration. In a Domain Knowledge Grouping configuration, features are grouped using their names or metadata of the features. In some cases, vertical grouping using process flow may comprise a Data-Driven Grouping configuration. In a Data-Driven Grouping configuration, features with similar characteristics across the process flow share the same group.

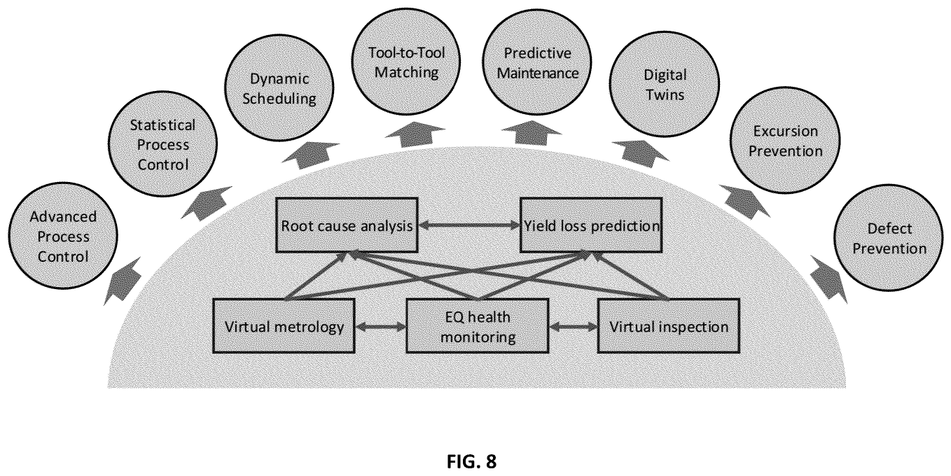

A non-limiting example of task grouping is provided in FIG. 8. It will be noted, this is only an example setting of how systems may be configured. This hierarchy may change in any cases, such as for instance from factory to factory. Tasks which may be aided with a VM solution can be context-specific so systems and methods herein may use single or multiple models to predict the one or more target variables.

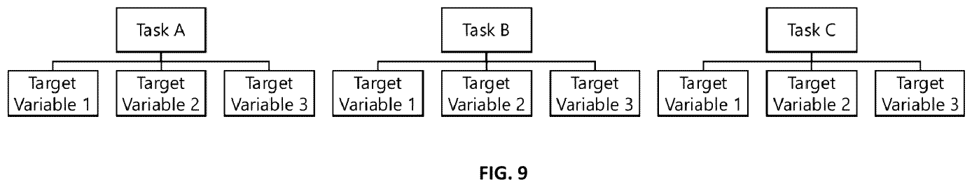

A non-limiting example of task grouping among data intelligent tasks is provided in FIG. 9 In some cases, task grouping among data intelligent tasks may comprise a One-Variable-One-Group configuration. In a One-Group-One-Variable configuration, each target variable from any of the tasks owns a dedicated group. In some cases, task grouping among data intelligent tasks may comprise a One-Task-One-Group configuration. In a One-Task-One-Group configuration, target variables from the same task are assigned to the same group. In some cases, task grouping among data intelligent tasks may comprise a Grouping by Target Variable Type configuration. In one example of a Grouping by Target Variable Type configuration, target variables that are binary variables belong to the same group and those that are continuous target variables belong to another. In some cases, task grouping among data intelligent tasks may comprise a Domain Knowledge Grouping configuration. In a Domain Knowledge Grouping configuration, tasks and target variables are group based on the domain knowledge from field engineers. In some cases, task grouping among data intelligent tasks may comprise a Data-Driven Grouping configuration. In a Data-Driven Grouping configuration, tasks and target variables are grouped together if they share similar data characteristics.

### Distance-Based Feature Grouping

In some embodiments, the clustering at 130 comprises using a distance clustering model to determine a correlation coefficient indicative of the object-level similarity between different objects within the enhanced dataset. In manufacturing processes, it is common to group the features based on their source of origin, name, or description. In some cases, however, this limits the ability to scale because it uses domain knowledge. Instead, distance-based agglomerative clustering may be used to group features with similar characteristics. In some cases, the clustering at 130 can include one or more of distance-based clustering, density-based clustering, hierarchical clustering, graph-based clustering, or distribution-based clustering.

As a non-limiting example, assume that the training data is represented by X, a matrix of size n×d where n is the number of samples and d is the number of features. Each feature can be represented as a vector xi which corresponds to the i^{th} column of X. To quantify the similarity between two features, xᵢ and xⱼ, we compute the correlation coefficient between the two vectors, denoted as cij. The correlation matrix C is composed of d column correlation vectors, cᵢ, where each vector represents feature i, consisting of the correlation coefficients between that feature and other d−1 features.

In some cases, similarity between features may be represented using one or more similarity metric. Some examples of a similarity metric can include correlation coefficients, distance, KL divergence, KS test, cosine similarity, or kernel similarity. In some cases, any combination of clustering method and similarity metric may be employed by systems and methods herein.

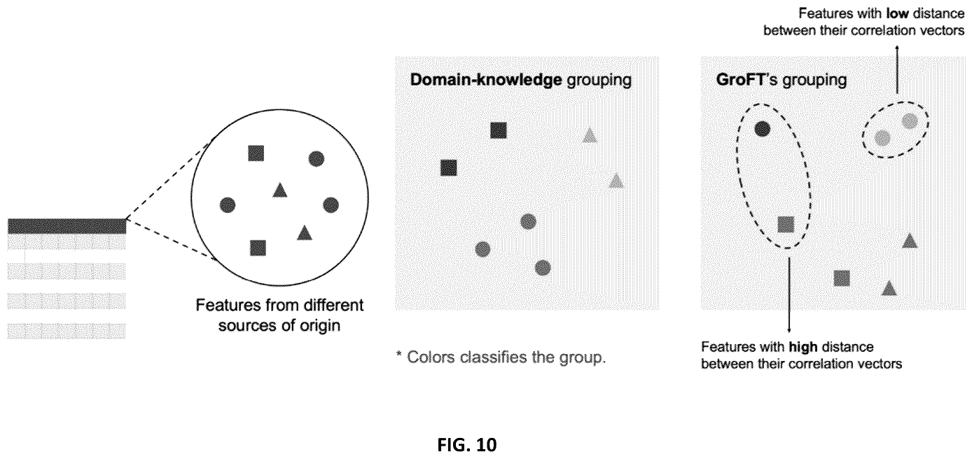

FIG. 10 provides a non-limiting example of this grouping, wherein the geometric shapes represent the column correlation vectors. At, for instance, operation 130 of the GroFT 330, features may be grouped with an agglomerative clustering algorithm using correlation vectors as inputs. Any two correlation vectors far from each other are quantifiably different in data characteristics and may have a low probability of being assigned to the same group. Various distance metrics, e.g., L1, L2, and cosine distance, can be applied to calculate the distance between any two vectors using the mathematical definition of each distance metric.

### Feature Transformation

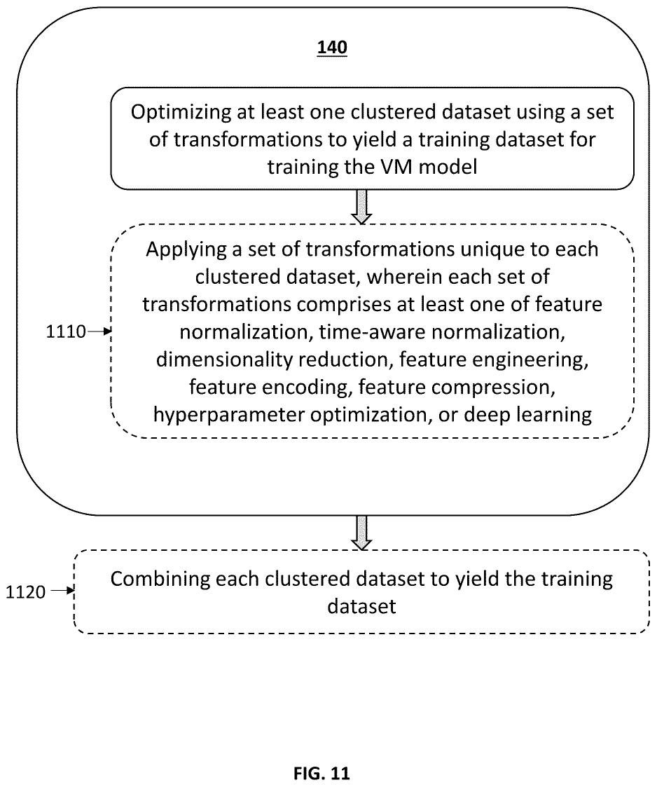

After feature grouping at 130, each feature group may undergo a set of unique feature transformations at 140 which can be dynamically optimized. A non-limiting example of feature transformation at 140 is provided in FIG. 11. In some embodiments, the optimizing at 140 optionally further comprises applying a set of transformations unique to each clustered dataset at 1110, wherein each set of transformations comprises at least one of feature normalization, time-aware normalization, dimensionality reduction, feature engineering, feature encoding, feature compression, hyper-parameter optimization (HPO), or deep learning. Each feature transformer may have different sets of hyper-parameters, depending on the algorithm, which can also be optimized. During hyper-parameter optimization (HPO), the choice of feature transformer and the optimal values of hyper-parameters may be optimized for each feature group. This process may naturally select the best feature transformation module for each feature group, ensuring that the most informative features are provided for the prediction model.

In some embodiments, the method 100 may optionally further comprise combining each clustered dataset at 1120 to yield the training dataset.

### Updating the Trained VM Model

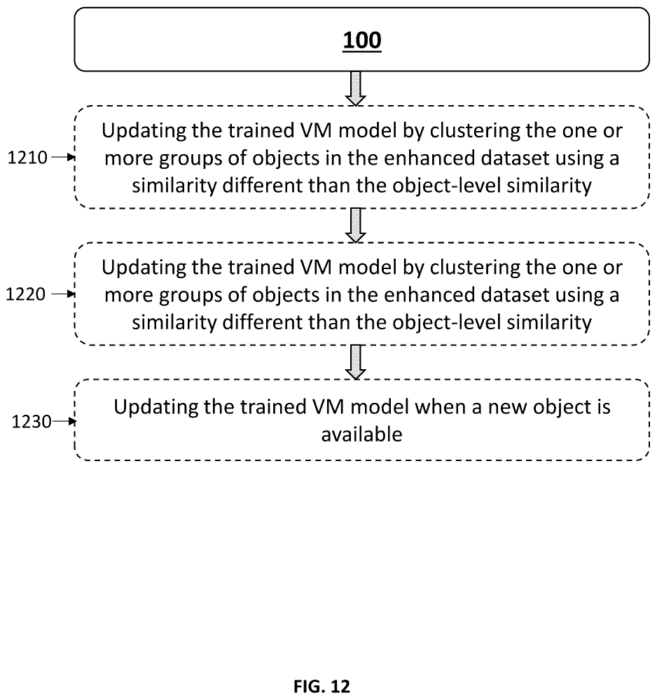

A non-limiting example of a method 1200 for updating the trained VM model is provided in FIG. 12. In some embodiments, the method 100 optionally further comprises updating the trained VM model at 1210 by clustering the one or more groups of objects in the enhanced dataset using a similarity different than the object-level similarity. In some embodiments, the method 100 optionally further comprises updating the trained model at 1220 by optimizing each clustered dataset using transformations different than the set of transformations. In some embodiments, the method 100 optionally further comprises updating the trained VM model at 1230 when a new object is available.

### Using the Predicted Metrology Measurement

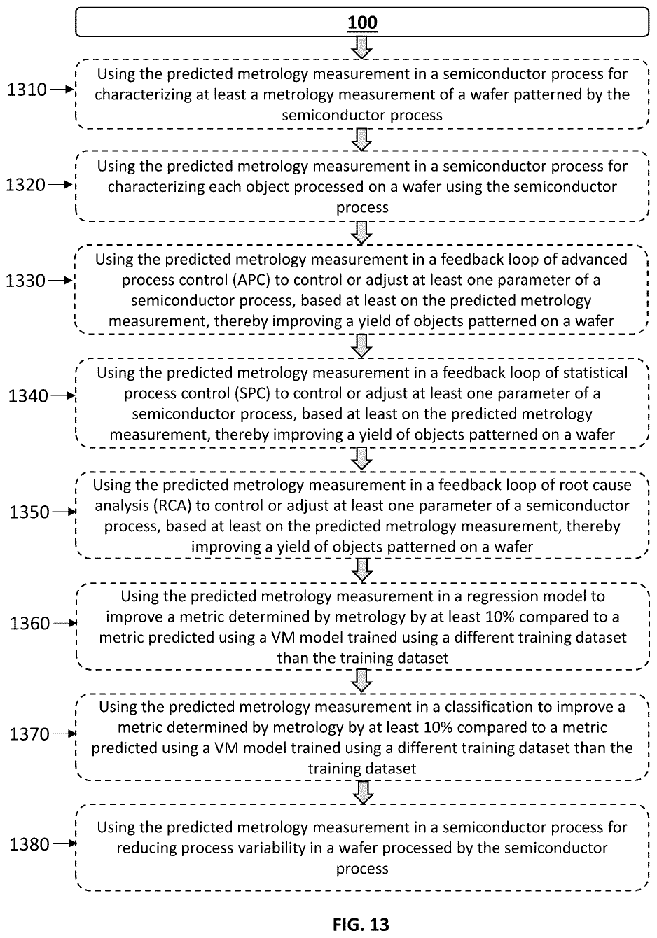

In some embodiments, the method 100 is used to produce one or more predicted metrology measurements at 150. A non-limiting example of a method 1300 for using a predicted metrology measurement is provided in FIG. 13. In some embodiments, the method 100 optionally further comprises using the predicted metrology measurement at 1310 in a semiconductor process for characterizing at least a real metrology measurement of a wafer processed by the semiconductor process. In some embodiments, the method 100 optionally further comprises using the predicted metrology measurement at 1320 in a semiconductor process for characterizing each object processed on a wafer using a semiconductor process. In some embodiments, using the trained dataset to train the VM model reduces computing time or computing resources by at least 10% compared to training a VM model using a different training dataset than the trained dataset. In some embodiments, the different training dataset comprises a dataset without object-level similarity.

In some cases, using the training dataset to train the VM model reduces computing time or computing resources by at least about 1% to 5% and increments therein. In some cases, using the training dataset to train the VM model reduces computing time or computing resources by at least about 5% to 10% and increments therein. In some cases, using the training dataset to train the VM model reduces computing time or computing resources by at least about 10% to 20% and increments therein.

In some embodiments, the method 100 optionally further comprises using the predicted metrology measurement at 1330 in a feedback loop of advanced process control (APC) to control or adjust at least one parameter of a semiconductor process, based at least on the predicted metrology measurement, thereby improving a yield of objects patterned on a wafer. Examples of parameters controlled by the APC can include manufacturing parameters (e.g., temperature, pressure, gas flow rates, deposition rate, etch rate, exposure, chemical concentrations, etc.), process parameters (e.g., cycle time, throughput, etc.), control loop performance of the APC (e.g., manipulated variable utilization, controlled variable performance, constraint violation frequency, etc.), and the like.

In some cases, using the predicted metrology measurement in APC at 1330 improves yield of objects patterned on a wafer at least about 1% to 5% and increments therein. In some cases, using the predicted metrology measurement in APC at 1330 improves yield of objects patterned on a wafer by at least about 5% to 10% and increments therein. In some cases, using the predicted metrology measurement in APC at 1330 improves yield of objects patterned on a wafer by at least about 10% to 20% and increments therein.

In some embodiments, the method 100 optionally further comprises using the predicted metrology measurement at 1340 in a feedback loop of statistical process control (SPC) to control or adjust at least one parameter of a semiconductor process, based at least on the predicted metrology measurement, thereby improving a yield of objects patterned on a wafer. Examples of parameters in SPC can include manufacturing parameters (e.g., temperature, pressure, gas flow rates, deposition rate, etch rate, exposure, chemical concentrations, etc.), process parameters (e.g., cycle time, throughput, etc.), process control parameters of the SPC (e.g., process capability indices, potential capability, process centering, etc.), and the like.

In some cases, using the predicted metrology measurement in SPC at 1340 improves yield of objects patterned on a wafer by at least about 1% to 5% and increments therein. In some cases, using the predicted metrology measurement in SPC at 1340 improves yield of objects patterned on a wafer by at least about 5% to 10% and increments therein. In some cases, using the predicted metrology measurement in SPC at 1340 improves yield of objects patterned on a wafer by at least about 10% to 20% and increments therein.

In some embodiments, the method 100 optionally further comprises using the predicted metrology measurement at 1350 in a feedback loop of root cause analysis (RCA) to control or adjust at least one parameter of a semiconductor process, based at least on the predicted metrology measurement, thereby improving a yield of objects patterned on a wafer. Examples of parameters in RCA can include manufacturing parameters (e.g., temperature, pressure, gas flow rates, deposition rate, etch rate, exposure, chemical concentrations, etc.), process parameters (e.g., cycle time, throughput, etc.), RCA parameters (e.g., key performance indicators, downtime, process efficiency, etc.), and the like. Examples of metrics in RCA can include defect density, yield rate, mean time to repair (MTTR), mean time between failures (MTBF), cost of poor quality (COPQ), first pass yield (FPY), escaped defects, process capability indices (Cp, Cpk), cycle time, root cause frequency, action closure rate, trend analysis, and the like.

In some cases, using the predicted metrology measurement in RCA at 750 improves yield of objects patterned on a wafer by at least about 1% to 5% and increments therein. In some cases, using the predicted metrology measurement in RCA at 1350 improves yield of objects patterned on a wafer by at least about 5% to 10% and increments therein. In some cases, using the predicted metrology measurement in RCA at 1350 improves yield of objects patterned on a wafer by at least about 10% to 20% and increments therein.

In some embodiments, the method 100 optionally further comprises using the predicted metrology measurement in a regression model at 1360 to improve a metric determined by metrology by at least 10% compared to a metric predicted using a VM model trained using a different training dataset than the training dataset. In some embodiments, the different training dataset comprises a dataset without object-level similarity. Examples of metrics can include manufacturing metrics (e.g., temperature, pressure, gas flow rates, deposition rate, etch rate, exposure, chemical concentrations, etc.), process control metrics (e.g., cycle time, throughput, etc.), MI metrics (e.g., presence of defects, confidence in determining defects, defect detection rates, etc.), and the like.

In some cases, using the predicted metrology measurement at 1360 improves a metric determined by metrology by at least about 1% to 5% and increments therein. In some cases, using the predicted metrology measurement at 1360 improves a metric determined by metrology by at least about 5% to 10% and increments therein. In some cases, using the predicted metrology measurement at 1360 improves a metric determined by metrology by at least about 10% to 20% and increments therein.

In some embodiments, the method 100 optionally further comprises using the predicted metrology measurement in a classification model at 1370 to improve a metric determined by metrology by at least 10% compared to a metric predicted using a VM model trained using a different training dataset than the training dataset. In some embodiments, the different training dataset comprises a dataset without object-level similarity. Examples of metrics can include manufacturing metrics (e.g., temperature, pressure, gas flow rates, deposition rate, etch rate, exposure, chemical concentrations, etc.), process control metrics (e.g., cycle time, throughput, etc.), MI metrics (e.g., presence of defects, confidence in determining defects, defect detection rates, etc.), and the like.

In some cases, using the predicted metrology measurement at 1370 improves a metric determined by metrology by at least about 1% to 5% and increments therein. In some cases, using the predicted metrology measurement at 1370 improves a metric determined by metrology by at least about 5% to 10% and increments therein. In some cases, using the predicted metrology measurement at 1370 improves a metric determined by metrology by at least about 10% to 20% and increments therein.

In some embodiments, the method 100 optionally further comprising using the predicted metrology measurement at 1380 in a semiconductor process for reducing process variability in a wafer processed by the semiconductor process. In some cases, process variability is determined using process capability indices such as Cp or CpK or other suitable statistical measures. In some cases, process variability can result from different factors such as: material variability, equipment variability, environmental factors, process parameter variability, wafer variability, human factors, and the like. In some cases, using the predicted metrology measurement at 1380 improves process variability by at least about 1% to 5% and increments therein. In some cases, using the predicted metrology measurement at 1380 improves process variability by at least about 5% to 10% and increments therein. In some cases, using the predicted metrology measurement at 1380 improves process variability by at least about 10% to 20% and increments therein.

In some cases, utilizing VM allows users to expect faster and deeper improvements in chamber consistency. In some cases, utilizing VM overcomes limitations of other methods by addressing and surpassing the constraints of such approaches. In some cases, utilizing VM provides high-resolution insights via full measurement data, providing detailed and precise data for better understanding. In some cases, utilizing VM provides multi-faceted analytical metrics for root cause analysis and quality improvements by utilizing diverse metrics for thorough analysis and quality enhancement.

### Validating the Trained VM Model

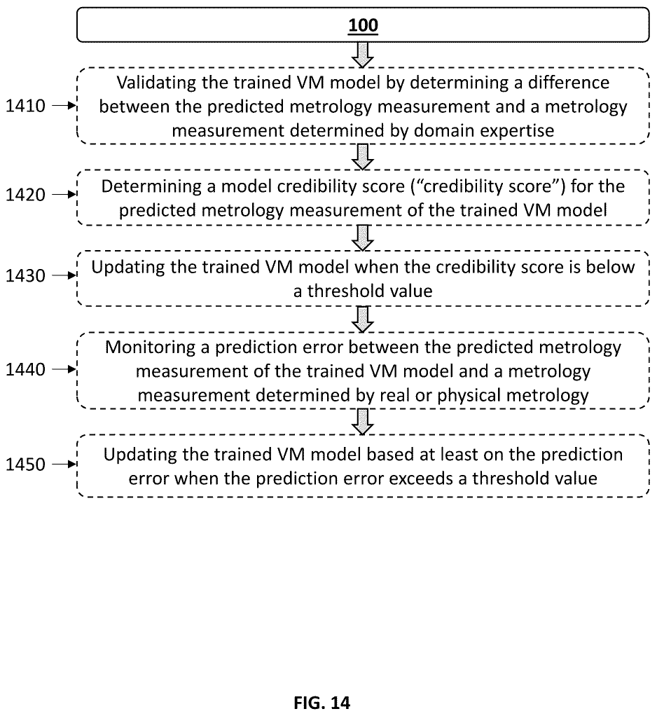

In some cases, the trained VM model may be validated by one or more systems and methods described herein. A non-limiting example of a method 1400 for validating the trained VM model is provided in FIG. 14. In some embodiments, the method 100 optionally further comprises validating the trained VM model at 1410 by determining a difference between the predicted metrology measurement and a real metrology measurement determined by domain expertise. In some embodiments, the trained VM model comprises a machine learning model. In some embodiments, the plurality of datasets and data types comprises at least one of structure or unstructured data, data form, or type of data, each associated with process equipment, or a process performed by the process equipment. In some embodiments, the plurality of datasets and data types is determined from fault detection and classification (FDC) data. In some embodiments, the plurality of datasets and data types is associated with metrology or characteristics of a wafer process by process equipment using a process, described herein. In some cases, the plurality of datasets and data types is associated metadata obtained from process equipment information, e.g., vendors, models, etc., and wafer event data, e.g., wafer history data.

In some embodiments, the method 100 optionally further comprises determining at 1420 a model credibility score (“credibility score”) for the predicted metrology measurement of the trained VM model. In some embodiments, the method 100 optionally further comprises updating the trained VM model at 1430 when the credibility score is below a threshold value. In some embodiments, the credibility score is determined using root mean square error (RMSE) or mean absolute error MAE. In some cases, the credibility score is determined using a normalized RMSE or MAE. For example, the RMSE or MAE can be normalized using a user-defined spec range. For example, the user-defined spec range can be an upper control limit and a lower control limit in the user's quality control standard. In some cases, the RMSE or MAE is normalized by dividing the RMSE or the MAE by the user-defined spec range. In some cases, other metrics may be used to determine when to update the trained VM model or to quantify the improved performance of the trained VM model, such as mean absolute error (MAE), mean square error (MSE), mean absolute percentage error (MAPE), R-squared (R²), other similar metrics, or any combination of metrics. In some cases, the choice of metric is specifically chosen for the task at hand. In some cases, the metric can be an error-based metric, e.g., RMSE, MAE, normalized RMSE, or normalized MAE, which can be helpful to understand improvement or better performance as the metric decreases in value. In some cases, the metric can be an accuracy-based metric, e.g., R², which can be helpful to understand improvement or better performance as the metric increases in value. In some embodiments, the threshold value is at least about 0.10. In some cases, the threshold value is at least about 0.01, 0.02, 0.03, 0.04, 0.05, 0.06, 0.07, 0.08, 0.09, 0.10, or greater, and increments therein,

In some embodiments, the method 100 optionally further comprises monitoring at 1440 a prediction error between the predicted metrology measurement of the trained VM model, and a metrology measurement determined by real or physical metrology. In some embodiments, the method 100 optionally further comprises updating at 1450 the trained VM model based at least on the prediction error when the prediction error exceeds a threshold value.

### EXAMPLES

While various examples of the present disclosure are shown and described herein, such examples are provided by way of example only. Numerous variations, changes, or substitutions may occur without departing from the present disclosure. It should be understood that various alternatives to the examples described herein may be employed.

### Example 1—Evaluation and Results of Systems and Methods Herein

As a non-limiting example, the benefits of the framework described herein may be demonstrated on two real-world metrology datasets with distinct tasks.

Datasets included data from the PHM Data Challenge 2016 (hereinafter “PHM-2016”), The Prognostics and Health Management Society, “PHM Data Challenge,” The Prognostics and Health Management Society, 2016, online, accessed 2024, which is incorporated herein by reference herein for all purposes. The dataset was published by The Prognostics and Health Management Society (PHM Society) via its annual data competition in 2016. The dataset is a regression modeling task on a semiconducting wafer CMP tool, acquiring an accurate prediction of the average removal rate of each wafer, given the equipment state of the CMP tool over the wafer processing time. The dataset contains 25 time-dependent features for each of the three chambers in the CMP process. Each wafer belongs to one out of two unique stages.

Since the officially provided training and test sets were not split by a specific timestamp, it is not practical to use them directly to benchmark any algorithm with updatability and adaptability. We recombine the two splits, sort the data samples chronologically, then re-divide the data into training and test by a 70:30 ratio. The re-splitting ensures that our evaluation reflects practical VM application and that there is no lookahead bias.

An additional dataset used for validation and evaluation herein is the SECOM dataset, (herein “SECOM”), M. McCann and A. Johnston, “SECOM,” UCI Machine Learning Repository, 2008, which is incorporated by reference herein for all purposes. Published by UC Irvine, this dataset is collected from a complex modern semiconductor manufacturing process containing 1567 samples from a fabrication production line. Each sample consists of data from 590 sensor measurements with a timestamp and a pass or fail test label, which transforms into a binary classification task. Only 104 out of 1567 samples are labeled fail, yielding an imbalanced dataset. The dataset also contains abundant missing values and artifacts that reflect the actual manufacturing data well.

As the dataset does not provide any training and test split, we divide the dataset with a 70:30 ratio after chronologically sorting as exactly done to the PHM-2016 dataset for evaluation purposes.

The non-limiting example of evaluation and results consists of two parts, each evaluating a specific component of an example framework, as described herein. First, we conduct an ablation study to evaluate the effect of sample coalescing and feature concatenation on the PHM-2016 dataset. This study may be used, for instance, to understand the contribution of individual components or features of a model or system. We demonstrate sample coalescing by combining the wafers from two stages containing different sets of wafers and feature concatenation by combining the features from three chambers. When feature concatenation is not applied, we run the experiment once per chamber and aggregate the results as reported in the next section. In this part, our baseline model adapts from ASCM34, which utilizes an adaptive time-aware normalizer (AN) to preprocess all features and target values before training a prediction model, which is an XGBoost regressor, described in, for instance: T. Chen and C. Guestrin, “XGBoost: A Scalable Tree Boosting System,” in Proceedings of the 22nd ACM SIGKDD International Conference on Knowledge Discovery and Data Mining, San Francisco, USA, 2016, which is incorporated by reference herein for all purposes.

Additionally, we demonstrate the performance of GroFT, which features into groups in a data-driven approach and applies different AN to each group by comparing with other baseline settings: 1) using a single AN to all features and 2) using distinct AN per feature group, grouped using domain knowledge, for example, by chamber for PHM-2016 dataset. Both datasets, PHM-2016 and SECOM, are used for our evaluation in this part. For the classification task on the SECOM dataset, the support vector machine (SVM) classifier is the prediction model. The choice of prediction models in either task does not affect the enhancement from sample coalescing, feature concatenation, or GroFT.

We enable HPO in all tasks, including hyper-parameters from AN, GroFT, and the prediction model, which are either an XGBoost regressor or an SVM classifier. For example, one of the AN's hyper-parameters, which implies the model's adaptability rate, is optimized to different values per each feature group when GroFT is enabled; otherwise, it shares the same value. During HPO, we divide the training set into two splits for training and validation using a 75:25 ratio. Each evaluation consists of 200 HPO trials using the Hyperopt algorithm, described in, for instance: J. Bergstra, D. Yamins and D. Cox, “Making a Science of Model Search: Hyperparameter Optimization in Hundreds of Dimensions for Vision Architectures,” Proceedings of Machine Learning Research, vol. 28, no. 1, pp. 115-123, 2013, which is incorporated by reference herein for all purposes. For the regression task on the PHM-2016 dataset, root mean squared error (RMSE) is minimized during HPO. For the classification task on the SECOM dataset, the F1 score is maximized. The optimal set of hyper-parameters is then applied to train the model with the entire training set and evaluated on the test set where the metrics are computed.

TABLE 1

| | Sample | Feature | | |
|---|---|---|---|---|
| Dataset | Coalescing | Concatenation | R² | RMSE |
| PHM- | No | No | 0.889, 0.437 | 12.311, 3.776 |
| 2016 | No | Yes | 0.951, 0.512 | 8.246, 3.521 |
| | No | No | 0.898 | 9.380 |
| | Yes | Yes | 0.932 | 7.413 |

Table 1 illustrates prediction performance on PHM-2016 dataset in R2 and RMSE when sample coalescing or feature concatenation is applied compared to the baseline. Metrics are reported per wafer stage when sample coalescing is not applied. For example, Table 1 shows the ablation study results when sample coalescing or feature concatenation is applied and evaluated on the PHM-2016 dataset. When sample coalescing is not enabled, the experiment is carried out once per wafer stage: A and B—two models have been trained and evaluated stage-wise. Performance metrics, R² and RMSE, are reported separately for each wafer stage. When feature concatenation is not enabled, features from only one of three chambers at a time are chosen. Three models have been trained and evaluated on both wafer stages. We aggregate metrics from three experiments and share the average results.

Results show that feature concatenation consistently improves the predictive performance of both R² and RMSE regardless of whether sample coalescing is enabled. On the other hand, sample coalescing preserves the model's accuracy while the number of models maintained reduces from two (one per wafer stage) to one. Applying sample coalescing and feature concatenation yields optimal accuracy with R² of 0.932 and RMSE of 7.413.

TABLE 2

| | Feature | | Performance | |
|---|---|---|---|---|
| Dataset | Transformer | Grouping Technique | R² | RMSE |
| PHM- | Shared | No grouping | 0.932 | 7.413 |
| 2016 | Group-wise | Domain knowledge | 0.934 | 7.296 |
| | Group-wise | Data-driven | 0.942 | 6.816 |
| | | | Accuracy | F1 Score |
| SECOM | Shared | No grouping | 0.887 | 0.104 |
| | Group-wise | Data-driven | 0.890 | 0.122 |

Table 2 illustrates prediction performance in two evaluation datasets with different task when using different feature transformation methodologies. In some cases, GroFT demonstrates the best predictive performance. For example, with optimal settings from the first method, further analysis compared GroFT with other data transformation baselines here, where sample coalescing and FDC are always enabled. The default option shares the same architecture and hyper-parameters of the feature transformer and then applies to all features uniformly. Group-wise feature transformation conversely uses different hyper-parameters per each feature group and transforms the feature values group-wise. To group the features, we compare our data-driven method using the clustering methodologies of the present disclosure to grouping by domain knowledge.

On the PHM-2016 dataset, using the best settings from Part I as the baseline, group-wise feature transformation using domain knowledge for grouping improves the performance in both metrics with R² of 0.934 and RMSE of 7.296. Furthermore, GroFT enhances the model performance, reaching R² and RMSE of 0.942 and 6.816, respectively. This suggests that in some cases domain knowledge does not always group the features that share similar data characteristics, and each feature may require specific treatment to best contribute to predictive performance.

On the SECOM dataset, GroFT performs better than the default option in both accuracy and F1 score, in some cases. It improves from 0.887 to 0.890 in accuracy and 0.104 to 0.112 in F1 score. In this dataset, where domain knowledge is limited, such grouping is impossible without costly domain knowledge, as usually occurs in manufacturing settings. GroFT's performance suggests a zero-cost data-driven alternative yet better predictive performance.

Systems and method herein may additionally apply sample coalescing, feature concatenation, and GroFT, to actual high-volume manufacturing data from a major global manufacturer. It may be demonstrated that systems and methods herein outperform other baselines in certain cases, as seen with PHM-2016 and SECOM datasets, illustrating the robustness of systems and methods across datasets in such cases.

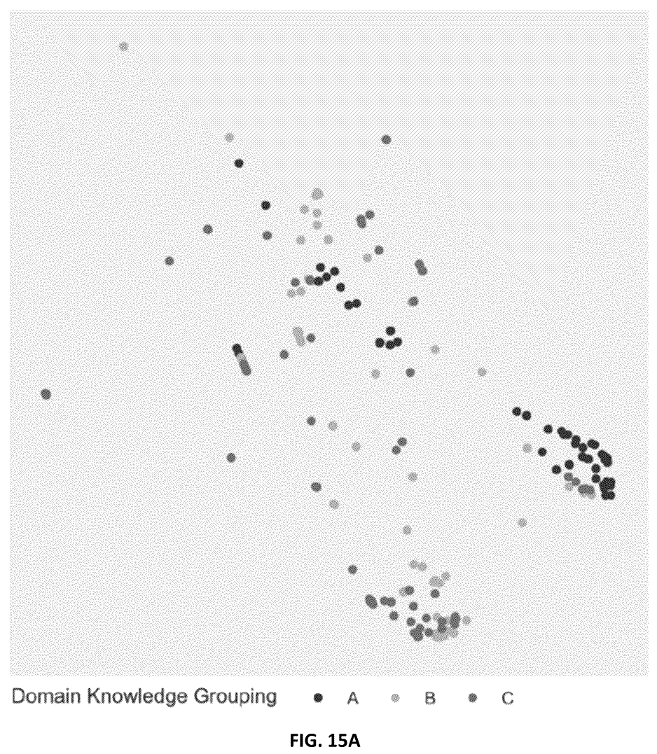

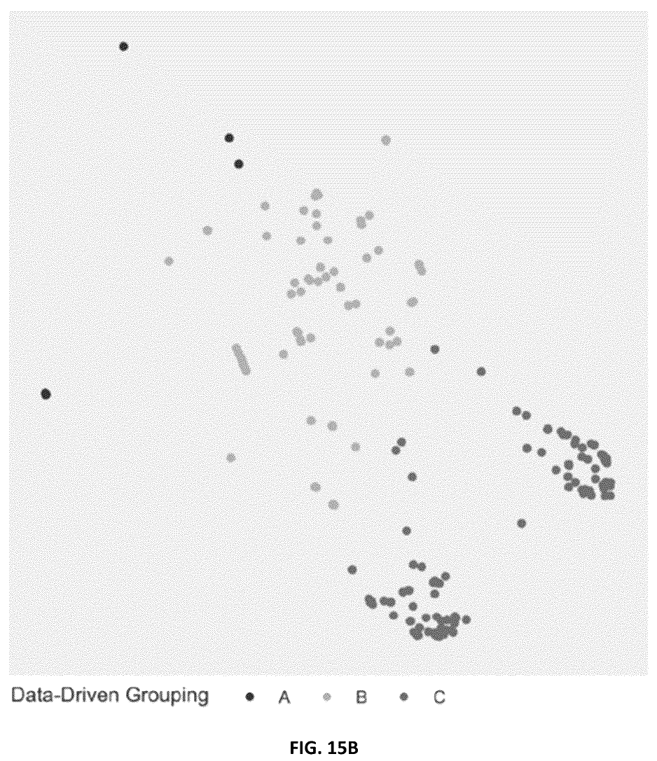

Similar to FIG. 10, FIGS. 15A-15B visualizes how GroFT divides the features from the PHM-2016 dataset into groups. Each point represents the correlation vector of a particular feature projected on a two-dimensional space. The distance between any pair of features implies their similarity based on their correlation coefficients against other features. Grouping the features using domain knowledge may assign similar features to different groups, while GroFT utilizes similarity measures to group them. Each feature group, consisting of features with similar characteristics, is then transformed using the same feature transformer, resulting in superior performance.

In addition to data aggregation methodologies with sample coalescing and feature concatenation, herein is proposed GroFT to enhance predictive performance in complex manufacturing datasets. Systems and methods described herein may be shown to improve predictive performance by applying optimized transformations to feature groups with similar characteristics. By reducing the reliance on domain knowledge for feature transformation, GroFT can minimize manual operations used during VM model development, streamlining the overall process. In a non-limiting example, data-driven GroFT, in addition to feature concatenation and sample coalescing, has been shown to reduce RMSE by 8.1% in the regression task and improves the F1 score by 18.2% in the classification task on real manufacturing datasets. Furthermore, the non-limiting example framework has been shown to outperform other methods on data from a high-volume semiconductor manufacturer, providing a scalable and automated approach to VM model development.

While various examples of the present disclosure are shown and described herein, such examples are provided by way of example only. Numerous variations, changes, or substitutions may occur without departing from the present disclosure. It should be understood that various alternatives to the examples described herein may be employed.

In some cases, the methods and systems for high-performing virtual metrology described herein comprise use of a computer program product. In some cases, the methods and systems for high-performing virtual metrology described herein comprise use of a computer program product for SEM and TEM data measurement and analysis.

### Computing Systems

In another aspect, disclosed herein is a system comprising at least one processor and instructions executable by the at least one processor to cause the at least one processor to perform operations comprising: (a) receiving (i) a sample dataset comprising a plurality of datasets and data types obtained from a plurality of sources and (ii) a feature dataset comprising a plurality of features obtained from at least one process of at least one source of the plurality of sources; (b) processing the sample dataset and the feature dataset to increase the dimensionality of the sample dataset and the feature dataset, thereby yielding an enhanced dataset; (c) determining one or more groups of objects within the enhanced dataset by clustering each group based at least on an object-level similarity to yield clustered datasets, wherein each object represents at least (i) one dataset and data type from the enhanced dataset and (ii) one feature from the enhanced dataset; (d) optimizing at least one clustered dataset using a set of transformations to yield a training dataset for training the VM model; and (e) using the training dataset to train the VM model to predict a metrology measurement

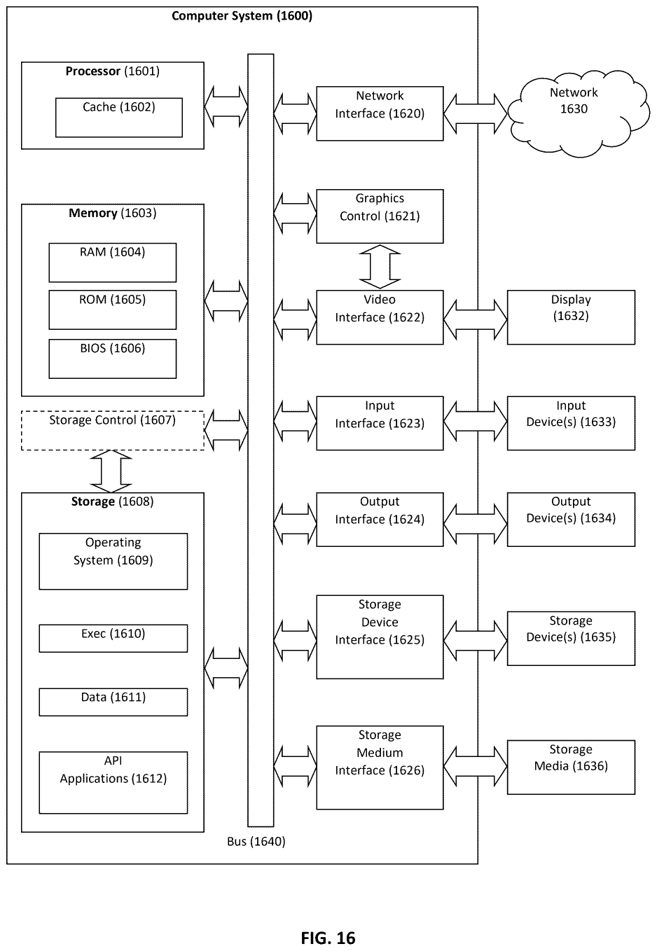

Referring to FIG. 16, a block diagram is shown depicting an example of a machine that includes a computer system 1600 (e.g., a processing or computing system) within which a set of instructions can execute for causing a device to perform or execute any one or more of the aspects and/or methodologies for static code scheduling of the present disclosure. The components in FIG. 16 are examples only and do not limit the scope of use or functionality of any hardware, software, embedded logic component, or a combination of two or more such components implementing particular embodiments.

Computer system 1600 may include one or more processors 1601, a memory 1603, and a storage 1608 that communicate with each other, and with other components, via a bus 1640. The bus 1640 may also link a display 1632, one or more input devices 1633 (which may, for example, include a keypad, a keyboard, a mouse, a stylus, etc.), one or more output devices 1634, one or more storage devices 1635, and various tangible storage media 1636. All of these elements may interface directly or via one or more interfaces or adaptors to the bus 1640. For instance, the various tangible storage media 1636 can interface with the bus 1640 via storage medium interface 1626. Computer system 1600 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 1600 includes one or more processor(s) 1601 (e.g., central processing units (CPUs) or general-purpose graphics processing units (GPGPUs)) that carry out functions. Processor(s) 1601 optionally contains a cache memory unit 1602 for temporary local storage of instructions, data, or computer addresses. Processor(s) 1601 are configured to assist in execution of computer readable instructions. Computer system 1600 may provide functionality for the components depicted in FIG. 16 as a result of the processor(s) 1601 executing non-transitory, processor-executable instructions embodied in one or more tangible computer-readable storage media, such as memory 1603, storage 1608, storage devices 1635, and/or storage medium 1636. The computer-readable media may store software that implements particular embodiments, and processor(s) 1601 may execute the software. Memory 1603 may read the software from one or more other computer-readable media (such as mass storage device(s) 1635, 1636) or from one or more other sources through a suitable interface, such as network interface 1620. The software may cause processor(s) 1601 to carry out one or more processes or one or more operations of one or more processes described or illustrated herein. Carrying out such processes or operations may include defining data structures stored in memory 1603 and modifying the data structures as directed by the software.

The memory 1603 may include various components (e.g., machine readable media) including, but not limited to, a random access memory component (e.g., RAM 1604) (e.g., static RAM (SRAM), dynamic RAM (DRAM), ferroelectric random access memory (FRAM), phase-change random access memory (PRAM), etc.), a read-only memory component (e.g., ROM 1605), and any combinations thereof. ROM 1605 may act to communicate data and instructions unidirectionally to processor(s) 1601, and RAM 1604 may act to communicate data and instructions bidirectionally with processor(s) 1601. ROM 1605 and RAM 1604 may include any suitable tangible computer-readable media described below. In one example, a basic input/output system 1606 (BIOS), including basic routines that help to transfer information between elements within computer system 1600, such as during start-up, may be stored in the memory 1603.

Fixed storage 1608 is connected bidirectionally to processor(s) 1601, optionally through storage control unit 1607. Fixed storage 1608 provides additional data storage capacity and may also include any suitable tangible computer-readable media described herein. Storage 1608 may be used to store operating system 1609, executable(s) 1610, data 1611, applications 1612 (application programs), and the like. Storage 1608 can also include an optical disk drive, a solid-state memory device (e.g., flash-based systems), or a combination of any of the above. Information in storage 1608 may, in appropriate cases, be incorporated as virtual memory in memory 1603.

In one example, storage device(s) 1635 may be removably interfaced with computer system 1600 (e.g., via an external port connector (not shown)) via a storage device interface 1625. Particularly, storage device(s) 1635 and an associated machine-readable medium may provide non-volatile and/or volatile storage of machine-readable instructions, data structures, program modules, and/or other data for the computer system 1600. In one example, software may reside, completely or partially, within a machine-readable medium on storage device(s) 1635. In another example, software may reside, completely or partially, within processor(s) 1601.

Bus 1640 connects a wide variety of subsystems. Herein, reference to a bus may encompass one or more digital signal lines serving a common function, where appropriate. Bus 1640 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 1600 may also include an input device 1633. In one example, a user of computer system 1600 may enter commands and/or other information into computer system 1600 via input device(s) 1633. Examples of an input device(s) 1633 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect®, Leap Motion®, or the like. Input device(s) 1633 may be interfaced to bus 1640 via any of a variety of input interfaces 1623 (e.g., input interface 1623) including, but not limited to, serial, parallel, game port, USB, FIREWIRE, THUNDERBOLT, or any combination of the above.

In particular embodiments, when computer system 1600 is connected to network 1630, computer system 1600 may communicate with other devices, specifically mobile devices and enterprise systems, distributed computing systems, cloud storage systems, cloud computing systems, and the like, connected to network 1630. Communications to and from computer system 1600 may be sent through network interface 1620. For example, network interface 1620 may receive incoming communications (such as requests or responses from other devices) in the form of one or more packets (such as Internet Protocol (IP) packets) from network 1630, and computer system 1600 may store the incoming communications in memory 1603 for processing. Computer system 1600 may similarly store outgoing communications (such as requests or responses to other devices) in the form of one or more packets in memory 1603 and communicated to network 1630 from network interface 1620. Processor(s) 1601 may access these communication packets stored in memory 1603 for processing.

Examples of the network interface 1620 include, but are not limited to, a network interface card, a modem, and any combination thereof. Examples of a network 1630 or network segment 1630 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 1630, may employ a wired and/or a wireless mode of communication. In general, any network topology may be used.

Information and data can be displayed through a display 1632. Examples of a display 1632 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 1632 can interface to the processor(s) 1601, memory 1603, and fixed storage 1608, as well as other devices, such as input device(s) 1633, via the bus 1640. The display 1632 is linked to the bus 1640 via a video interface 1622, and transport of data between the display 1632 and the bus 1640 can be controlled via the graphics control 1621. In some embodiments, the display is a video projector. In some embodiments, the display is a head-mounted display (HMD) such as a VR headset. In further embodiments, suitable VR headsets include, by way of non-limiting examples, HTC Vive®, Oculus Rift®, Samsung Gear VR®, Microsoft HoloLens®, Razer OSVR®, FOVE VR®, Zeiss VR One®, Avegant Glyph®, Freefly VR® headset, and the like. In still further embodiments, the display is a combination of devices such as those disclosed herein.

In addition to a display 1632, computer system 1600 may include one or more other peripheral output devices 1634 including, but not limited to, an audio speaker, a printer, a storage device, and any combinations thereof. Such peripheral output devices may be connected to the bus 1640 via an output interface 1624. Examples of an output interface 1624 include, but are not limited to, a serial port, a parallel connection, a USB port, a FIREWIRE port, a THUNDERBOLT port, and any combinations thereof.

In addition, or as an alternative, computer system 1600 may provide functionality as a result of logic hardwired or otherwise embodied in a circuit, which may operate in place of or together with software to execute one or more processes or one or more operations of one or more processes described or illustrated herein. Reference to software in this present disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The operations of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Select televisions, video players, and digital music players with optional computer network connectivity are suitable for use in the system described herein. Suitable tablet computers, in various embodiments, include those with booklet, slate, and convertible configurations.

In some embodiments, the computing device includes an operating system configured to perform executable instructions. The operating system is, for example, software, including programs and data, which manages the device's hardware and provides services for execution of applications. Suitable server operating systems include, by way of non-limiting examples, FreeBSD®, OpenBSD®, NetBSD®, Linux®, Apple® Mac OS X Server®, Oracle Solaris®, Windows Server®, and Novell NetWare®. Suitable personal computer operating systems include, by way of non-limiting examples, Microsoft Windows®, Apple Mac® OS X, UNIX®, and UNIX-like operating systems such as GNU/Linux®. In some embodiments, the operating system is provided by cloud computing. Suitable mobile smartphone operating systems include, by way of non-limiting examples, Nokia Symbian® OS, Apple® iOS, Research In Motion BlackBerry® OS, Google® Android®, Microsoft® Windows Phone® OS, Microsoft® Windows Mobile OS, Linux®, and Palm® WebOS. Suitable media streaming device operating systems include, by way of non-limiting examples, Apple TV®, Roku®, Boxee®, Google TV®, Google Chromecast®, Amazon Fire®, and Samsung® HomeSync®. Suitable video game console operating systems include, by way of non-limiting examples, Sony® PS3®, Sony® PS4®, Microsoft® Xbox 360®, Microsoft Xbox One®, Nintendo Wii®, Nintendo Wii U®, and Ouya®. Suitable virtual reality headset systems include, by way of non-limiting example, Meta Oculus®.

### Non-Transitory Computer Readable Storage Mediums

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In another aspect, disclosed herein is a computer program product for training a virtual metrology (VM) model, the computer program product comprising at least one non-transitory computer-readable medium having computer-readable program code portions embodied therein, the computer-readable program code portions comprising: an executable portion configured to receive (i) a sample dataset comprising a plurality of datasets and data types obtained from a plurality of sources and (ii) a feature dataset comprising a plurality of features obtained from at least one process of at least one source of the plurality of sources; an executable portion configured to process the sample dataset and the feature dataset to increase the dimensionality of the sample dataset and the feature dataset, thereby yielding an enhanced dataset; an executable portion configured to determine one or more groups of objects within the enhanced dataset by clustering each group based at least on an object-level similarity to yield clustered datasets, wherein each object represents at least (i) one dataset and data type from the enhanced dataset and (ii) one feature from the enhanced dataset; an executable portion configured to optimize at least one clustered dataset using a set of transformations to yield a training dataset for training the VM model; and an executable portion configured to use the training dataset to train the VM model to predict a metrology measurement.

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the present disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Applications

In some embodiments, a computer program includes a web application. In light of the present disclosure provided herein, a web application, in various embodiments, utilizes one or more software frameworks and one or more database systems. In some embodiments, a web application is created upon a software framework such as Microsoft®.NET or Ruby on Rails® (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® structured query language (SQL) Server, mySQL™, and Oracle®. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML® (AJAX), Flash Actionscript, Javascript®, or Silverlight®. In some embodiments, a web application is written to some extent in a server-side coding language such as Active Server Pages® (ASP), ColdFusion®, Perl®, Java®, JavaServer Pages® (JSP), Hypertext Preprocessor® (PHP), Python®, Ruby®, Tcl®, Smalltalk®, WebDNA®, or Groovy®. In some embodiments, a web application is written to some extent in a database query language such as Structured Query Language (SQL). In some embodiments, a web application integrates enterprise server products such as IBM Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft Silverlight®, Java®, and Unity®.

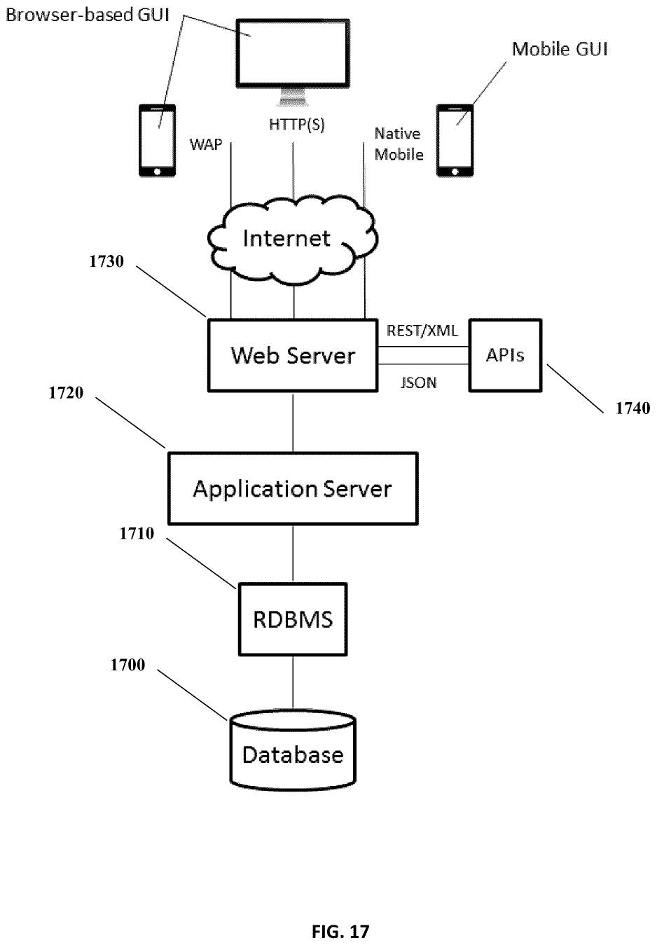

Referring to FIG. 17, in a particular embodiment, an application provision system comprises one or more databases 1700 accessed by a database management system (DBMS) 1710. Suitable DBMSs include Firebird®, MySQL®, NOSQL®, PostgreSQL®, SQLite®, Oracle Database®, Microsoft SQL Server®, IBM DB2®, IBM Informix®, SAP Sybase®, SAP Sybase®, Teradata®, PostGIS®, Apache® Hive, Apache® Impala, time-series databases, graph databases, key-value storage, and the like. In this embodiment, the application provision system further comprises one or more application severs 1720 (such as Java® servers, .NET® servers, PHP® servers, and the like) and one or more web servers 1730 (such as Apache®, IIS®, GWS® and the like). The web server(s) optionally expose one or more web services via app application programming interfaces (APIs) 1740. Via a network, such as the Internet, the system provides browser-based and/or mobile native user interfaces. In some cases, a DBMS may be a relational DBMS.

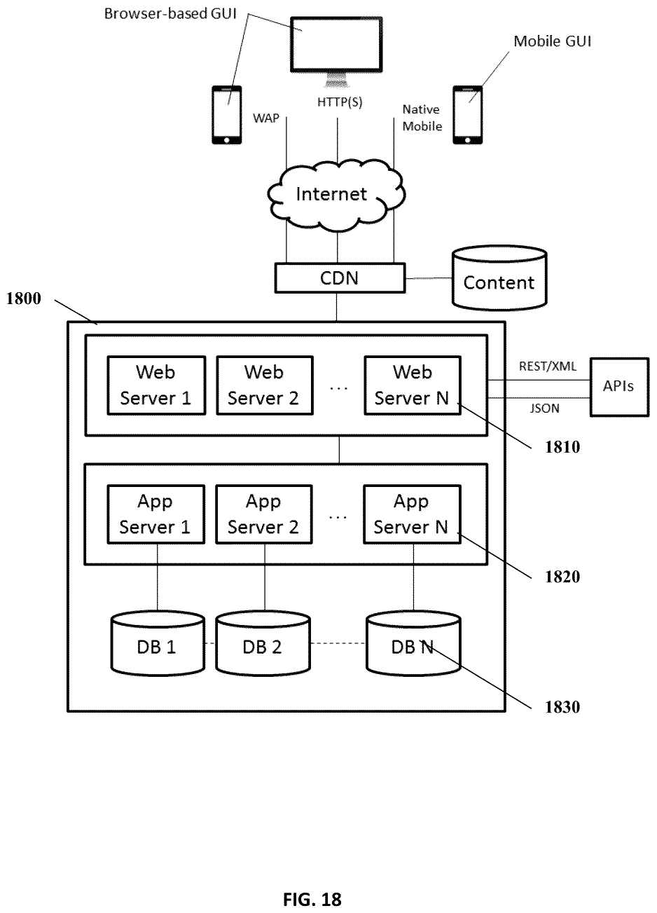

Referring to FIG. 18, in a particular embodiment, an application provision system alternatively has a distributed, cloud-based architecture 1800 and comprises elastically load balanced, auto-scaling web server resources 1810 and application server resources 1820 as well synchronously replicated databases 1830.

### Mobile Applications

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the present disclosure provided herein, a mobile application is created by methodologies using hardware, languages, and development environments. Mobile applications are written in several languages. Suitable programming languages include, by way of non-limiting examples, C, C++, C#, Objective-C, Java®, Javascript®, Pascal®, Object Pascal®, Python™, Ruby®, VB.NET®, WML®, and XHTML/HTML with or without CSS, or combinations thereof.

Suitable mobile application development environments are available from several sources. Commercially available development environments include, by way of non-limiting examples, AirplaySDK®, alcheMo®, Appcelerator®, Celsius®, Bedrock®, Flash Lite®, .NET Compact Framework®, Rhomobile®, and WorkLight Mobile Platform®. Other development environments are available without cost including, by way of non-limiting examples, Lazarus®, MobiFlex®, MoSync®, and Phonegap®. Also, mobile device manufacturers distribute software developer kits including, by way of non-limiting examples, iPhone® and iPad® (iOS) SDK, Android® SDK, BlackBerry® SDK, BREW SDK, Palm® OS SDK, Symbian® SDK, webOS® SDK, and Windows® Mobile SDK.

Several commercial sources are available for distribution of mobile applications including, by way of non-limiting examples, Apple® App Store, Google® Play, Chrome® WebStore, BlackBerry® App World, App Store® for Palm devices, App Catalog® for webOS, Windows® Marketplace for Mobile, Ovi Store for Nokia® devices, Samsung® Apps, and Nintendo® DSi Shop.

### Standalone Applications

In some embodiments, a computer program includes a standalone application, which is a program that is run as an independent computer process, not an add-on to an existing process, e.g., not a plug-in. Standalone applications are often compiled. A compiler is a computer program(s) that transforms source code written in a programming language into binary object code such as assembly language or machine code. Suitable compiled programming languages include, by way of non-limiting examples, C, C++, Objective-C®, COBOL®, Delphi®, Eiffel®, Java®, Lisp®, Python®, Visual Basic®, and VB.NET®, or combinations thereof. Compilation is often performed, at least in part, to create an executable program. In some embodiments, a computer program includes one or more executable compiled applications. Additionally, microservices related to Python® and JavaScript® may be used.

### Web Browser Plug-Ins

In some embodiments, the computer program includes a web browser plug-in (e.g., web extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Several web browser plug-ins may include Adobe Flash Player®, Microsoft Silverlight®, and Apple QuickTime®. In some embodiments, the toolbar comprises one or more web browser extensions, add-ins, or add-ons. In some embodiments, the toolbar comprises one or more explorer bars, tool bands, or desk bands.

In view of the present disclosure provided herein, several plug-in frameworks are available that enable development of plug-ins in various programming languages, including, by way of non-limiting examples, C++, Delphi®, Java®, PHP®, Python®, and VB.NET®, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft Internet Explorer®, Mozilla Firefox®, Google Chrome®, Apple Safari®, Opera Software Opera®, and KDE Konqueror®. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google Android® browser, RIM Blackberry® Browser, Apple Safari®, Palm Blazer®, Palm WebOS® Browser, Mozilla Firefox® for mobile, Microsoft Internet Explorer Mobile®, Amazon Kindle Basic Web®, Nokia Browser®, Opera Software Opera Mobile®, and Sony PSP® browser.

### Software Modules

In some embodiments, the platforms, systems, media, and methods disclosed herein include software, server, and/or database modules, or use of the same. In view of the present disclosure provided herein, software modules are created by methodologies using machines, software, and languages. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases (DB), or use of the same. In view of the present disclosure provided herein, many databases are suitable for storage and retrieval data. In various embodiments, suitable databases include, by way of non-limiting examples, relational databases, non-relational databases, object-oriented databases, object databases, entity-relationship model databases, associative databases, XML databases, time-series databases, graph databases, and the like. Further non-limiting examples include SQL, PostgreSQL®, MySQL®, Oracle®, DB2®, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### Terms and Definitions

Unless otherwise defined, all technical terms used herein have the same meaning as commonly understood by one of ordinary skill in the art to which this present disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions may occur without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that systems, methods and structures within the scope of these claims and their equivalents be covered thereby.

1. A method for training a virtual metrology (VM) model, the method comprising:
(a) receiving (i) a sample dataset comprising a plurality of datasets and data types obtained from a plurality of sources and (ii) a feature dataset comprising a plurality of features obtained from at least one process of at least one source of the plurality of sources;
(b) processing the sample dataset and the feature dataset to increase a dimensionality of the sample dataset and the feature dataset to yield an enhanced dataset;
(c) determining one or more groups of objects within the enhanced dataset by clustering each group based at least on an object-level similarity to yield clustered datasets, wherein each object represents at least (i) one dataset and data type from the enhanced dataset and (ii) one feature from the enhanced dataset;
(d) optimizing at least one clustered dataset using a set of transformations to yield a training dataset for training the VM model; and
(e) using the training dataset to train the VM model to predict a metrology measurement.

2. The method of claim 1, wherein the sample dataset comprises at least one of (i) real metrology measurements of at least one wafer processed by a semiconductor process or (ii) parameters of the semiconductor process.

3. The method of claim 1, wherein the feature dataset comprises at least one of (i) sensor measurements from at least one process equipment used to process a wafer by a semiconductor process or (ii) parameters of the semiconductor process.

4. The method of claim 1, further comprising generating the sample dataset obtained from the plurality of sources, wherein the plurality of sources comprises at least one processing equipment having at least one chamber in a semiconductor process.

5. The method of claim 1, further comprising generating the feature dataset obtained from the at least one process of the at least one source, wherein the at least one process comprises at least one recipe used to process a wafer by a semiconductor process.

6. The method of claim 5, wherein the at least one process of the at least one source comprises a process from an upstream process or from a downstream process, relative to the at least one source.

7. The method of claim 1, wherein the processing in (b) comprises concatenating the sample dataset and the feature dataset to increase the dimensionality of the enhanced dataset.

8. The method of claim 1, wherein the dimensionality resulting from (b) comprises at least two dimensions of parameters, samples, tasks, or processes.

9. The method of claim 1, wherein the training dataset has a lower dimensionality than the at least one clustered dataset.

10. The method of claim 1, wherein the clustering in (c) comprises using (i) a data-driven, group-wise feature transformation or (ii) domain knowledge.

11. The method of claim 1, wherein the clustering in (c) comprises using a distance clustering model to determine a correlation coefficient indicative of the object-level similarity between different objects within the enhanced dataset.

12. The method of claim 1, wherein the optimizing in (d) further comprises applying a set of transformations unique to each clustered dataset, wherein each set of transformations comprises at least one of feature normalization, time-aware normalization, dimensionality reduction, feature engineering, feature encoding, feature compression, hyperparameter optimization, or deep learning.

13. The method of claim 12, further comprising combining each clustered dataset to yield the training dataset.

14. The method of claim 1, further comprising updating the trained VM model by clustering the one or more groups of objects in the enhanced dataset using a similarity different than the object-level similarity.

15. The method of claim 1, further comprising updating the trained VM model by optimizing each clustered dataset using transformations different than the set of transformations.

16. The method of claim 1, further comprising updating the trained VM model when a new object is available.

17. The method of claim 1, further comprising using the predicted metrology measurement in a semiconductor process for reducing process variability in a wafer processed by the semiconductor process.

18. The method of claim 1, further comprising using the predicted metrology measurement in a semiconductor process for characterizing at least a real metrology measurement of a wafer processed by the semiconductor process.

19. The method of claim 1, further comprising using the predicted metrology measurement in a semiconductor process for characterizing each object processed on a wafer using the semiconductor process.

20. The method of claim 1, wherein using the training dataset to train the VM model reduces computing time or computing resources by at least 1%-5% compared to training a VM model using a different training dataset than the training dataset.

21. The method of claim 20, wherein the different training dataset comprises a dataset without object-level similarity.

22. The method of claim 1, further comprising validating the trained VM model by determining a difference between the predicted metrology measurement and a real metrology measurement determined by domain expertise.

23. The method of claim 1, wherein the trained VM model comprises a machine learning model.

24. The method of claim 1, wherein the plurality of datasets and data types comprises at least one of (i) structured or unstructured data, (ii) data form, or (iii) type of data, each associated with process equipment or a process performed by the process equipment.

25. The method of claim 1, wherein the plurality of datasets and data types is determined from fault detection and classification (FDC) data.

26. The method of claim 1, wherein the plurality of datasets and data types is associated with metrology or characteristics of a wafer processed by process equipment using a process.

27. The method of claim 1, further comprising determining a credibility score for the predicted metrology measurement of the trained VM model.

28. The method of claim 27, further comprising updating the trained VM model when the credibility score does not meet a threshold value.

29. The method of claim 28, wherein the credibility score is determined using normalized root mean square error (RMSE) or normalized mean absolute error MAE.

30. The method of claim 28, wherein the threshold value is at least about 0.10.

31. The method of claim 1, further comprising monitoring a prediction error between the predicted metrology measurement of the trained VM model and a real metrology measurement determined by real or physical metrology.

32. The method of claim 31, further comprising updating the trained VM model based at least on the prediction error when the prediction error exceeds a threshold value.

33. (canceled)

34. A system comprising at least one processor and instructions executable by the at least one processor to cause the at least one processor to perform operations comprising:
(a) receiving (i) a sample dataset comprising a plurality of datasets and data types obtained from a plurality of sources and (ii) a feature dataset comprising a plurality of features obtained from at least one process of at least one source of the plurality of sources;
(b) processing the sample dataset and the feature dataset to increase the dimensionality of the sample dataset and the feature dataset, thereby yielding an enhanced dataset;
(c) determining one or more groups of objects within the enhanced dataset by clustering each group based at least on an object-level similarity to yield clustered datasets, wherein each object represents at least (i) one dataset and data type from the enhanced dataset and (ii) one feature from the enhanced dataset;
(d) optimizing at least one clustered dataset using a set of transformations to yield a training dataset for training the VM model; and
(e) using the training dataset to train the VM model to predict a metrology measurement.
